(19) United States
(12) Patent Application Publication
(10) Pub. No.: US 2010/0153997 A1
(43) Pub. Date: Jun. 17, 2010

(54) INTERACTIVE TELEVISION SYSTEM WITH TEMPLATES FOR MANAGING VENDOR-SPECIFIC VIDEO-ON-DEMAND CONTENT

(75) Inventors: Joseph P. Baumgartner, Tulsa, OK (US); Todd A. Walker, Bixby, OK (US)

Correspondence Address: ROPES & GRAY LLP, PATENT DOCKETING 39/361, 1211 AVENUE OF THE AMERICAS, NEW YORK, NY, 10036-8704, US

(73) Assignee: UNITED VIDEO PROPERTIES, INC., Tulsa, OK (US)

(21) Appl. No.: 12/623,541

(22) Filed: Nov. 23, 2009

Related U.S. Application Data
(63) Continuation of application No. 10/762,833, filed on Jan. 21, 2004, now abandoned.

(51) Int. Cl. H04N 5/445

(52) U.S. Cl. 725/39

(57) ABSTRACT

An interactive television system is provided in which a user can use an interactive television application to access and request media-on-demand programming from one or more specific vendors. The interactive television application may display vendor-specific interface screens that allow the user to access and request content from a particular vendor. The application may generate a vendor-specific interface screen by incorporating vendor-specific interface elements into an interface template. The template may include vendor-invariant interface elements and attributes for the incorporated elements. The generated vendor-specific interface screen may then be displayed on the user equipment. The system may also include a remote server to provide vendor-specific interface elements and templates to the application, and memory on the user equipment where these elements and templates may be stored.

### BACKGROUND OF THE INVENTION

This invention relates to television systems, and more particularly, to an interactive television program guide application that provides templates for managing video-on-demand content.

Interactive television systems are known to provide interactive television program guide applications. An interactive television program guide application may be configured to provide a number of interactive features such as television program listings, video-on-demand services, web-browsing services, games, home shopping, and other interactive features, to the user.

In a typical interactive television system, the interactive television program guide application is implemented on a set-top box. The user interacts with the interactive television program guide application, for example, to access video-on-demand programming and associated content, using a remote control.

In a computer environment, the user accesses an online interactive television program guide application to obtain desired information such as information associated with video-on-demand programming.

Given the potentially large number of available video-on-demand programs and video-on-demand service providers, it is difficult to organize these programs in such a manner that a user will easily locate a video-on-demand program of interest. It may be desirable to allow each video-on-demand provider with a customizable video-on-demand display screen. However, in traditional interactive television program guides there is generally no mechanism for implementing a given vendor's branding motif without manually making changes to the guide.

It is therefore an object of the present invention to allow a video-on-demand vendor to brand or sponsor the video-on-demand content that is made available through an interactive television program guide application. For example, it may be desirable to allow a vendor (e.g., HBO) to have a particular video-on-demand screen (e.g., an HBO video-on-demand listings screen) within the interactive television program guide application that is branded using that vendor's motif on the video-on-demand display (e.g., the HBO logo and color scheme, etc.).

### SUMMARY OF THE INVENTION

In accordance with the present invention, an interactive television program guide application is provided that allows a video-on-demand vendor to brand or sponsor the video-on-demand content that is made available through the interactive television program guide application.

An interactive television program guide application may be used to display listings of available video-on-demand (VOD) content offerings. For example, a list of video-on-demand movies or other programs may be provided on a VOD listings screen. (The VOD screen may be made up of multiple pages or portions that are accessed by paging or scrolling if desired.) A user may access the VOD listings screen by selecting an on-screen menu option on a suitable program guide menu, by pressing a dedicated button on a remote control, or by using other suitable user interface arrangements.

The video-on-demand listings screen may be associated with a particular vendor (e.g., HBO, Showtime, Starz, etc.). This vendor may own rights in the content being offered, may act as an aggregator or an intermediary in selecting and collecting suitable content, or may otherwise be commercially and artistically associated with the selection and sponsoring of the video-on-demand content whose listings are displayed on the VOD listing screen.

The video-on-demand vendor is typically distinct from the operator of the cable system, satellite system, broadcast system, or other television distribution facility from which users obtain their services. Such operators (typically referred to as multiple system operators or MSOs) have their own opportunity to brand and select content. Because of the brand name recognition of the vendors and because of other services provided by the vendors, the MSOs may allow the vendors to individually brand one or more VOD listings screens that are displayed in the interactive television program guide application.

The MSOs are typically the customers of the service provider who provides the interactive television program guide (“the program guide provider”). The program guide provider develops and maintains the interactive television program guide software, databases, and systems used in operating the interactive television program guide application. The interactive television program guide application may be implemented on a set-top box, a satellite receiver, a computer, or any other suitable user equipment in the homes of the users (subscribers) who are associated with the MSOs.

In order to accommodate many different MSOs, each of which may wish to provide their users with a different set of vendor-branded VOD interfaces, the interactive television program guide application has VOD interface templates. These templates may allow the interactive television program guide application to be easily customized for each MSO and each vendor without extensive recoding or revision of the underlying program guide application. The VOD interface templates allow the program guide provider to sell a generic program guide platform to many different MSOs. The program guide provider (or the MSO or a third party) may use the templates to customize the VOD listings screens it needs for each MSO. For example, the template allows one MSO to offer the program guide application to its subscribers in a form in which the guide has an HBO-branded VOD interface and for a different MSO to offer the program guide to its subscribers in a form in which the guide has a Starz-branded VOD interface. Other MSOs may require that the program guide have no special vendor branding for the VOD listings, whereas other MSOs may require that the program guide support vendor branding from multiple vendors.

A video-on-demand listings screen motif that is specific to a particular vendor may have a number of distinct elements. For example, the vendor may specify that a particular background graphic be used for the vendor-branded VOD listings screen. The vendor may also specify that a particular color scheme be used for the screen or that the vendor's logo be included. Other items (e.g., background sound, video content, etc.) may also be specified by the vendor.

Some screen elements may not be vendor specific, such that some embodiments of the present invention include an interface template with at least some vendor-invariant interface elements. For example, while some option buttons may be vendor specific, certain option buttons may always be available on the video-on-demand listings screen, regardless of which vendor is branding the screen. These options and other unchanging graphical elements may only be modified by the program guide provider (e.g., by recoding the software). Therefore, in certain embodiments of the present invention, the vendor-specific interface screen may incorporate both vendor-specific and vendor-invariant interface elements.

The vendor-branding video-on-demand listings screen template arrangement may accommodate both custom graphics and display elements (e.g., a custom background, color scheme, and logo) and fixed (uncustomizable) elements (e.g., standard selectable buttons).

If desired, the template function may be used in other interactive television applications that support video-on-demand content or other suitable content ordering screens. For example, vendor-specific display screens may be provided by an interactive shopping application, an interactive Internet application, an interactive game application, or any other suitable interactive television application that allow the user to access and request video-on-demand content (or other suitable content) provided by and/or branded by a particular vendor. The vendor-specific screens may include vendor-specific interface elements that make the screen identifiable and characteristic of the particular vendor. The interactive television application may generate the vendor-specific display screens by incorporating the vendor-specific interface elements into an interface template. The interface template may also include invariant elements (e.g., standard buttons) that may appear on all such interface screens. The invariant elements are generally not vendor-specific.

The system may also include a remote server that may provide the vendor-specific interface elements and/or the interface templates to the application. The user equipment on which the application is implemented may include memory to store or cache vendor-specific interface elements and/or interface templates. The application, when retrieving the interface templates or vendor-specific interface elements, may access the stored elements or templates instead of re-requesting the same elements or templates from the remote server.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of an illustrative interactive television system in accordance with various embodiments of the present invention.

FIG. 2 is a diagram of illustrative user television equipment in accordance with various embodiments of the present invention.

FIG. 3 is a diagram of additional illustrative user television equipment in accordance with various embodiments of the present invention.

FIG. 4 is a diagram of an illustrative remote control in accordance with various embodiments of the present invention.

FIG. 5 is a diagram of illustrative user computer equipment in accordance with various embodiments of the present invention.

FIG. 6 is a generalized diagram of illustrative user equipment in accordance with various embodiments of the present invention.

FIG. 7 shows an illustrative menu screen in accordance with various embodiments of the present invention.

FIG. 8 shows an illustrative program guide screen in accordance with various embodiments of the present invention.

FIG. 9 is an illustrative display screen showing how a flip banner that contains program listings information for the current channel may be displayed as an overlay over video of the current channel in accordance with various embodiments of the present invention.

FIG. 10 is an illustrative display screen showing how a browse banner that contains program listings information for a channel that may differ from the current channel may be displayed as an overlay over video of the current channel in accordance with various embodiments of the present invention.

FIG. 11 shows an illustrative program guide screen in accordance with various embodiments of the present invention.

FIG. 12 is an illustrative display screen showing how an interactive television application may provide a user with an opportunity to set a program reminder in accordance with various embodiments of the present invention.

FIG. 13 is an illustrative display screen showing how a reminder may be provided for a user in accordance with various embodiments of the present invention.

FIG. 14 is a display screen showing an illustrative video-on-demand menu that may be used to select a category of video-on-demand content in accordance with various embodiments of the present invention.

FIG. 15 is a display screen showing an illustrative video-on-demand menu screen that may be used to locate a desired type of movie in accordance with various embodiments of the present invention.

FIG. 16 shows an illustrative title menu that may be used to select a video-on-demand title of interest in accordance with various embodiments of the present invention.

FIGS. 17a and 17b are illustrative video-on-demand information screens that may be used to access video-on-demand content in accordance with various embodiments of the present invention.

FIG. 18 is an illustrative display screen showing how video-on-demand playback controls may be displayed while video-on-demand content is being displayed for the user in accordance with various embodiments of the present invention.

FIGS. 19a and 19b are illustrative display screens showing how a user's scheduled recordings may be presented and selected in an interactive list in accordance with various embodiments of the present invention.

FIGS. 20a and 20b are illustrative display screens showing how a user's recordings may be presented and selected from an interactive list in accordance with various embodiments of the present invention.

FIG. 21 is an illustrative display screen showing how video for a recording selected from the list of FIG. 18 may be displayed for the user in accordance with various embodiments of the present invention.

FIG. 22 is an illustrative display screen showing how the user may be provided with options that allow the user to schedule a recording of a desired program in accordance with various embodiments of the present invention.

FIG. 23a is an illustrative display screen showing how a user may set parental controls for a given program in accordance with various embodiments of the present invention.

FIG. 23b is an illustrative display screen showing how a user may block content by creating a time-based parental control setting in accordance with various embodiments of the present invention.

FIG. 24 is an illustrative display screen that may be used to select a specific vendor for video-on-demand content in accordance with various embodiments of the present invention.

FIG. 25 is an illustrative program guide display screen with video-on-demand vendor-specific options in accordance with various embodiments of the present invention.

FIG. 26 is an illustrative vendor-specific interface screen that may be used to select a category of video-on-demand content in accordance with various embodiments of the present invention.

FIG. 27 is an illustrative vendor-specific interface screen that may be used to select a category or title of video-on-demand content in accordance with various embodiments of the present invention.

FIG. 28 is an illustrative interface template that may be used to generate a vendor-specific interface screen in accordance with various embodiments of the present invention.

FIG. 29 is a flow chart of illustrative steps involved in using an interactive television system to generate and display a vendor-specific interface screen for providing video-on-demand content in accordance with various embodiments of the present invention.

### DETAILED DESCRIPTION OF THE PREFERRED EMBODIMENTS

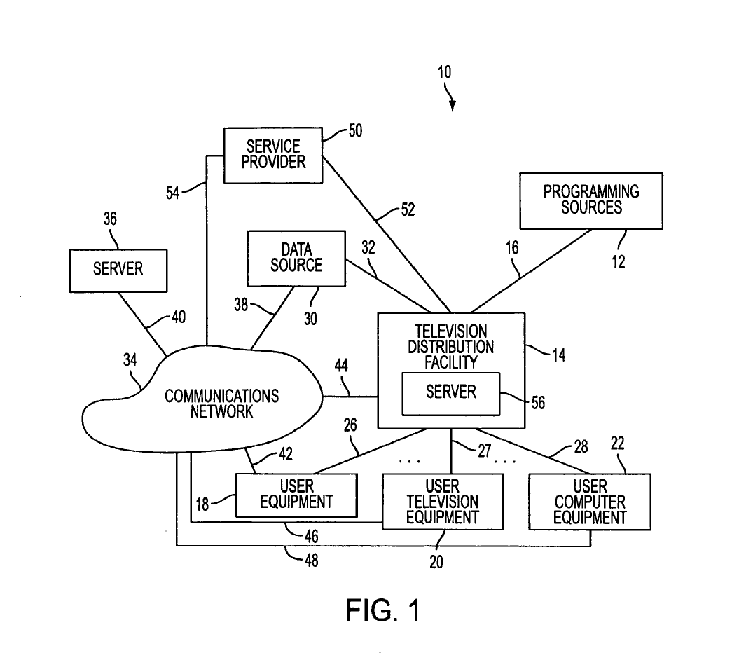

An illustrative interactive television system 10 in accordance with the present invention is shown in FIG. 1. Content such as television programming and other media, such as digital music, may be provided from programming sources 12 to television distribution facilities such as television distribution facility 14 using communications path 16. Programming sources 12 may be any suitable sources of television and music programming, such as television and music production studios, etc.

Television distribution facility 14 may be a cable system headend, a satellite television distribution facility, a television broadcast facility, or any other suitable facility for distributing television and music programming to users. There are typically numerous television distribution facilities 14 in system 10, but only one is shown in FIG. 1 to avoid overcomplicating the drawings.

Communications path 16 may be a satellite path, a fiber-optic path, a cable path, or any other suitable wired or wireless communications paths or a combination of such paths.

Television distribution facility 14 may be connected to various user equipment devices 18. Such user equipment 18 may, for example, be located in the homes of users. User equipment 18 may include user television equipment 20 or user computer equipment 22.

The user equipment may receive television and music programming and other information from television distribution facility 14 over communications paths such as communications paths 26, 27, and 28. The user equipment may also transmit signals to television distribution facility 14 over paths 26, 27, and 28. Paths 26, 27, and 28 may be cables or other wired connections, or wireless connections for broadcast or satellite links.

Data source 30 may include a program listings database that is used to provide the user equipment with information for the interactive television program guide, such as scheduled broadcast times, titles, channels, ratings information (e.g., parental ratings and critic's ratings), detailed title descriptions, genre or category information (e.g., sports, news, movies, etc.), information on actors and actresses, running times, etc. Data source 30 may also be used to provide advertisements (e.g., program guide advertisements and advertisements for other interactive television applications), real-time data such as sports scores, stock quotes, news, weather, etc. Although data source 30 is drawn as an individual box in FIG. 1, data source 30 and the other system components of FIG. 1 may be provided using equipment at one or more locations. Systems components are drawn as single boxes in FIG. 1 to avoid over-complicating the drawings.

Data source 30 may provide program schedule information and other data to television distribution facility 14 over communications path 32 for distribution to the associated user equipment over paths 26, 27, and 28. Communications path 32 may be any suitable communications path such as a satellite communications path or other wireless path, a fiber-optic or other wired communications path, a path that supports Internet communications, a combination of such paths, etc. Data source 30 may provide program schedule information and other data to the user at user equipment 18 over path 38, communications network 34, and path 42. Path 42 may be a wired path such as a telephone line, a cable path, a fiber-optic path, a satellite path, a wireless path, a combination of such paths, or any other suitable path.

User equipment devices such as user television equipment and personal computers may use the program schedule information to display program listings and information on digital music for the user. An interactive television program guide application or other suitable application may be used to display such information on the user's display.

An on-line program guide and other interactive television services may be provided using a server connected to communications network 34 such as server 36. Server 36 may receive program schedule information and other data from data source 30 via communications path 38, communications network 34, and communications path 40. Paths 38 and 40 may be satellite paths, fiber-optic paths, wired paths, etc. Communications network 34 may be any suitable communications network, such as the Internet, the public switched telephone network, a packet-based network, etc.

User equipment 18 may access on-line program guide information and other information from server 36 via communications path 42. User equipment 18 may also access the on-line program guide and other services on server 36 via communications path 26, television distribution facility 14, and communications path 44. For example, a cable modem or other suitable equipment may be used by user equipment 18 to communicate with television distribution facility 14. Television distribution facility 14 may communicate with communications network 34 over any suitable path 44, such as a wired path, a cable path, a fiber-optic path, a satellite path, a wireless path, a combination of such paths, etc.

User equipment such as user television equipment 20 and user computer equipment 22 may access the on-line program guide and server 36 using similar arrangements. User television equipment 20 may access the on-line program guide and server 36 using communications path 46 or using path 27, television distribution facility 14, and path 44. User computer equipment 22 may access the on-line program guide and server 36 using communications path 48 or using path 28, television distribution facility 14, and path 44. Paths 46 and 48 may be any suitable paths, such as wired paths, cable paths, fiber-optic paths, satellite paths, wireless paths, a combination of such paths, etc.

Program guide application functions and the functions of other interactive television applications may be supported using server 36 and other servers connected to communications network 34 such as server 56. Interactive television applications may also be supported by servers or other suitable equipment at one or more service providers such as service provider 50. For example, a home shopping service may be supported by a service provider such as service provider 50 that has sales representatives, order fulfillment facilities, account maintenance facilities, and other equipment for supporting interactive home shopping features. A home shopping application that is implemented using the user equipment may be used to access the service provider to provide these features to the user. The user equipment may access service provider 50 via television distribution facility 14 and communications path 52 or via communications network 34 and communications path 54. Communications paths such as paths 52 and 54 may be any suitable paths, such as wired paths, cable paths, fiber-optic paths, satellite paths, wireless paths, a combination of such paths, etc.

Another example of an interactive television application is a home banking application. A home banking service may be supported using personnel at facilities such as service provider 50. An interactive home banking application that is implemented using the user equipment may access the home banking service via television distribution facility 14 and communications path 52 or via communications network 34 and communications path 54.

If desired, an interactive television application such as a network-based video recorder or a video-on-demand application may be supported using server 56, server 36, or equipment at service provider 50. Video-on-demand content and video recorded using a network-based video recorder arrangement may be stored on server 56 or server 36 or at service provider 50 and may be provided to the user equipment when requested by users. An interactive television application may be used to support the functions of a personal video recorder (sometimes called a digital video recorder) that is implemented using user equipment 18. Illustrative equipment that may be used to support personal video recorder functions include specialized personal video recorder devices, integrated receiver decoders (IRDs), set-top boxes with integrated or external hard drives, or personal computers with video recording capabilities.

If desired, applications such as the interactive television program guide application, a home shopping application, a home banking application, a video-on-demand application, game applications, and other applications (e.g., applications related to e-mail and chat or other communications functions, etc.) may be provided as separate applications that are accessed through a navigation shell application (i.e., a menu application with menu options corresponding to the applications). The features of such applications may be combined. For example, games, video-on-demand services, home shopping, network-based video recorder functions, personal video recorder functions, navigational functions, program guide functions, communications functions, and other suitable functions may be provided using one application or any other suitable number of applications.

Moreover, the interactive television program guide application, the home banking application, the home shopping application, the network-based video recorder and personal video recorder applications, the video-on-demand application, the gaming applications, communications applications, and navigational applications, are only a few illustrative examples of the types of interactive television applications that may be supported by system 10. Other suitable applications that may be supported include, news services, web browsing and other Internet services, and interactive wagering services (e.g., for wagering on horse races and the like).

The interactive television application or applications that are used in interactive television system 10 may be implemented locally on the user equipment. The applications may also be implemented in a distributed fashion (e.g., using a client-server architecture in which the user equipment serves at least partly and for at least some of the time, as the client and a server such as server 56 at television distribution facility 14, server 36, or other suitable equipment acts as the server. Other distributed architectures may also be used if desired. Moreover, some or all of the interactive television system features of system 10 may be provided using operating system software or middleware software. Such operating system software and middleware may be used instead of or in combination with application-level software. Regardless of the particular arrangement used to implement interactive television features related to program guides, home shopping, home banking, video-on-demand, Internet, communications, etc., the software that supports these features may be referred to as an application or applications.

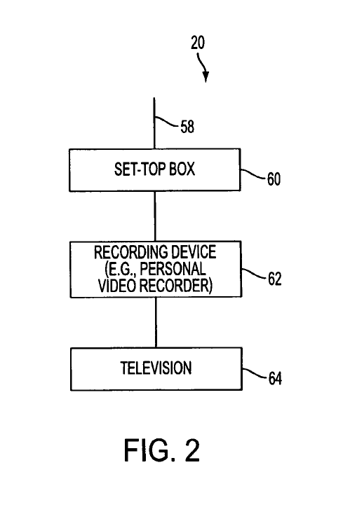

Illustrative user television equipment 20 that is based on a set-top box arrangement is shown in FIG. 2. Input/output 58 may be connected to communications paths such as paths 27 and 46. Input/output functions may be provided by one or more wires or communications paths, but are shown as a single path in FIG. 2 to avoid overcomplicating the drawing. Television programming and other information may be received using input/output 58. Commands and requests and other information from the user may also be transmitted over input/output 58.

Set-top box 60 may be any suitable analog or digital set-top box (e.g., a cable set-top box). Set-top box 60 may contain an analog tuner for tuning to a desired analog television channel. Set-top box 60 may also contain digital decoding circuitry for receiving digital television and music channels. Both analog and digital channels may be handled together if desired. Multiple tuners may be provided (e.g., to handle simultaneous watch and record functions). Set-top box 60 may be an integrated receiver decoder (IRD) that handles satellite television. If desired, set-top box 60 may have circuitry for handling cable, over-the-air broadcast, and satellite content. Set-top box 60 may include a storage device (e.g., a digital storage device such as a hard disk drive) for providing recording capabilities. Box 60 may also be connected to a recording device 62 such as a video cassette recorder, personal video recorder, or other device or devices with storage capabilities.

Set-top box 60 contains a processor (e.g., a microcontroller or microprocessor or the like) that is used to execute software applications. Set-top box 60 may contain memory such as random-access memory for use when executing applications. Nonvolatile memory may also be used (e.g., to launch a boot-up routine and other instructions). Hard disk storage in box 60 or in recording device 62 may be used to back up data and to otherwise support larger databases and storage requirements than may be supported using random-access memory approaches.

Set-top box 60 may have infrared (IR) or other communications circuitry for communicating with a remote control or wireless keyboard. Set-top box 60 may also have dedicated buttons and a front-panel display. The front-panel display may, for example, be used to display the current channel to which the set-top box is tuned.

Set-top box 60 may also have communications circuitry such as a cable modem, an integrated services digital network (ISDN) modem, a digital subscriber line (DSL) modem, a telephone modem, a wireless modem, etc. for communications with other equipment. Such communications may involve the Internet or any other suitable communications networks or paths. If desired, the components of set-top box 60 may be integrated into other user equipment (e.g., a television or videocassette recorder).

Recording device 62 may be used to record videos provided by set-top box 60. For example, if set-top box 60 is tuned to a given television channel, the video signal for that television channel may be passed to recording device 62 for recording on a videocassette, compact disc, digital video disk, or internal hard drive or other storage device. Recording device 62 may have communications circuitry such as a cable modem, an ISDN modem, a DSL modem, a telephone modem, etc. for communications with other equipment. Such communications may involve the Internet or any other suitable communications networks or paths. The components of recording device 62 may be integrated into other user equipment (e.g., a television, stereo equipment, etc.).

Recording device 62 may be controlled using a remote control or other suitable user interface. If desired, video recorder functions such as start, stop, record, etc. and other functions for device 62 may be controlled by set-top box 60. For example, set-top box 60 may control recording device 62 using infrared commands directed toward the remote control inputs of recording device 62 or set-top box 60 may control recording device 62 using other wired or wireless communications paths between box 60 and device 62.

The output of recording device 62 may be provided to television 64 for display to the user. If desired, multiple recording devices 62 or no recording device 62 may be used. If recording device 62 is not present or is not being actively used, the video signals from set-top box 60 may be provided directly to television 64. Any suitable television or monitor may be used to display the video. In the equipment of FIG. 2 and the other equipment of system 10, the audio associated with various video items is typically distributed with those video items and is generally played back to the user as the videos are played.

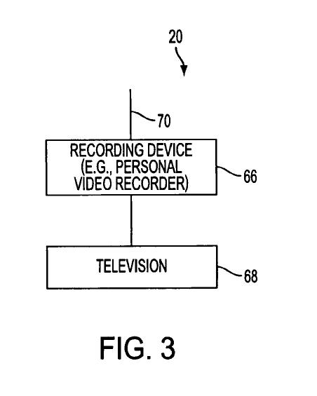

Another illustrative arrangement for user television equipment 20 is shown in FIG. 3. In the example of FIG. 3, user television equipment 20 includes a recording device 66 such as a digital video recorder (e.g., a personal video recorder (PVR)) that uses a hard disk or other storage for recording video or may be a digital video disc recorder, compact disc recorder, videocassette recorder, or other suitable recording device. Equipment 20 of FIG. 3 may also include a television 68. Input/output 70 may be connected to communications paths such as paths 27 and 46. Television programming and other information may be received using input/output 70. Commands and requests and other information from the user may be transmitted over input/output 70.

Recording device 66 may contain at least one analog tuner for tuning to a desired analog television channel. Recording device 66 may also contain digital decoding circuitry for receiving digital television and music channels. If desired, recording device 66 may contain circuitry for handling both analog and digital channels. Recording device 66 also contains a processor (e.g., multiple tuners may be provided, a microcontroller or microprocessor or the like) that is used to execute software applications. Recording device 66 may contain memory such as random-access memory for use when executing applications. Nonvolatile memory may also be used to store a boot-up routine or other instructions. The hard disk and other storage in recording device 66 may be used to support databases (e.g., program guide databases or interactive television application databases). The hard disk or other storage in recording device 66 may also be used to record video such as television programs or video-on-demand content or other content provided to recording device 66 over input/output 70.

Recording device 66 may have IR communications circuitry or other suitable communications circuitry for communicating with a remote control. Recording device 66 may also have dedicated buttons and a front-panel display. The front-panel display may, for example, be used to display the current channel to which the recording device is tuned.

Recording device 66 may also have communications circuitry such as a cable modem, an ISDN modem, a DSL modem, a telephone modem, a wireless modem, etc. for communications with other equipment. Such communications may involve the Internet or other suitable communications networks or paths.

If desired, recording device 66 may include a satellite receiver or other equipment that has wireless communications circuitry for receiving satellite signals.

Recording device 66 of FIG. 3 or recording device 62 of FIG. 2 may record new video while previously recorded video is being played back on television 68 or 64. This allows users to press a pause button during normal television viewing. When the pause button is pressed, the current television program is stored on the hard disk of digital video recorder 66. When the user presses play, the recorded video may be played back. This arrangement allows the user to seamlessly pause and resume television viewing. Recording device 66 and 62 may also be used to allow a user to watch a previously-recorded program while simultaneously recording a new program.

The set-top box arrangement of FIG. 2 and the digital video recorder set-top box arrangement of FIG. 3 are merely illustrative. Other arrangements may be used if desired. For example, user television equipment may be based on a WebTV box, a personal computer television (PC/TV), or any other suitable television equipment arrangement. If desired, the functions of components such as set-top box 60, digital video recorder 66, a WebTV box, or PC/TV or the like may be integrated into a television or personal computer or other suitable device.

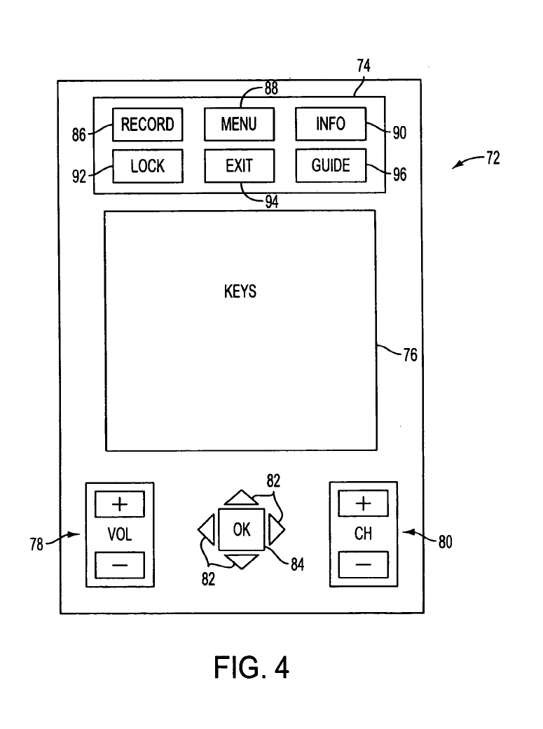

An illustrative remote control 72 for operating user television equipment 20 (or suitable user computer equipment 22) is shown in FIG. 4. Remote control 72 may have function keys 74 and other keys 76 such as keypad keys, power on/off keys, pause, stop, fast-forward and reverse keys, etc. Volume up and down keys 78 may be used for adjusting the volume of the audio portion of a video. Channel up and down keys 80 may be used to change television channels and to access content on virtual channels. Cursor keys 82 may be used to navigate on-screen menus. For example, cursor keys 82 may be used to position an on-screen cursor, indicator, or highlight (sometimes all generically referred to herein as a highlight or highlight region) to indicate interest in a particular option or other item on a screen displayed by the interactive television application.

An OK key 84 (sometimes called a select or enter key) may be used to select on-screen options that the user has highlighted.

Keys 74 may include a record key 86 for initiating recordings. Menu button 88 may be used to direct the interactive television application to display a menu on the user's display screen (e.g., on television 64 or 68 or on a suitable monitor or computer display). Info button 90 may be used to direct the interactive television application to display an information display screen. If the user has highlighted a particular program listing, for example, pressing the info button 90 may direct the interactive television application to provide additional program schedule information related to that program listing (e.g., a program summary, actor information, etc.).

Lock button 92 may be used to modify access privileges. For example, a parent may use lock button 92 or on-screen options to establish parental control settings for the interactive television application. The parental control settings may be time-based settings (e.g., to prevent a child from watching television during a particular time block such as from 3:00 PM to 5:00 PM). The parental control settings may also be used to block programming based on rating, channel, program title, etc. A locked or blocked program is typically not viewable until the interactive television application is provided with a suitable personal identification number (PIN). Once this PIN has been entered, the interactive television program will unlock the user's equipment and allow the locked content to be accessed.

Exit button 94 may be used to exit the. interactive television application or to exit a portion of the interactive television application. Guide button 96 may be used to invoke the interactive television program guide.

The keys shown in FIG. 4 are merely illustrative. Other keys or buttons may be provided if desired. For example, a music button may be used to access music with the interactive television application. An edit button may be used to edit stored content (e.g., to remove commercials, remove portions of a video, etc.). Alphanumeric buttons may be used to enter alphanumeric characters. A last or back button may be used to browse backward in the interactive television application (e.g., to return to a previous channel or display screen). Video recorder function buttons such as a play button, pause button, stop button, rewind button, fast-forward button, and record button, may be used to control video recorder functions (local or network-based) in system 10. A help key may be used to invoke help functions such as context-sensitive on-screen help, etc.

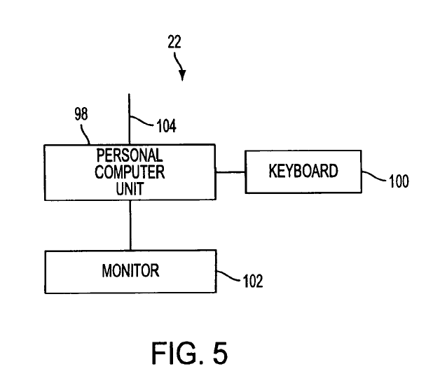

Illustrative user computer equipment 22 is shown in FIG. 5. In the arrangement of FIG. 5, personal computer unit 98 may be controlled by the user using keyboard 100 or other suitable user input device, such as a trackball, mouse, touch pad, touch screen, voice recognition system, a remote control such as remote control 72 of FIG. 4, etc. Video content such as television programming and interactive television application display screens may be displayed on monitor 102. Television programming, video-on-demand content, video recordings played back from a network-based video recorder, and other information may be received from paths 28 and 48 (FIG. 1) using input/output 104. The user may also send commands and other information used during interactions with the interactive television application and system 10 over input/output line 104.

Personal computer unit 98 may contain a television or video card such as television tuner card for decoding analog and digital television channels and for handling streaming video content. Multiple video cards (e.g., tuner cards) may be provided if desired. An illustrative television tuner card that may be used may contain an analog television tuner for tuning to a given analog channel and digital decoding circuitry for filtering out a desired digital television or music channel from a packetized digital data stream. Any suitable card or components in computer unit 98 may be used to handle video and other content delivered via input/output line 104 if desired.

Personal computer unit 98 may contain one or more processors (e.g., microprocessors) that are used to run the interactive television application or a portion of the interactive television application.

Storage in personal computer unit 98 such as a hard drive, DVD drive, CD drive, or other suitable storage device or devices may be used to store video and other content. For example, the interactive television application and personal computer unit 98 may use this storage to provide the functions of a personal video recorder.

User equipment 18 such as user television equipment 20 and user computer equipment 22 may be used with network equipment such as server 56, server 36, and equipment at service providers such as service provider 50 of FIG. 1 to provide network-based video recording functions. Video recording functions may be provided by storing copies of television programs and other video content on a remote server (e.g., server 56 or server 36 of FIG. 1) or other network-based equipment such as equipment at a service provider such as service provider 50.

Video recordings may be made in response to user commands that are entered at user equipment 18. In a personal video recorder arrangement, the interactive television application may be used to record video locally on the user equipment in response to the user commands. In a network-based video recorder arrangement, the interactive television application may be used to record video or to make virtual recordings on network equipment such as server 36, 56, or equipment at service provider 50 in response to the user commands. The user commands may be provided to the network equipment over the communications paths shown in FIG. 1. The personal video recorder arrangement and the network-based video recorder arrangement can support functions such as fast-forward, rewind, pause, play, and record.

To avoid unnecessary duplication in a network-based video recorder environment, the system 10 may provide network-based video recording capabilities by using virtual copies or recordings. With this approach, each user may be provided with a personal area on the network that contains a list of that user's recordings. The video content need only be stored once (or a relatively small number of times) on the network equipment, even though a large number of users may have that video content listed as one of their recordings in their network-based video recorder personal area.

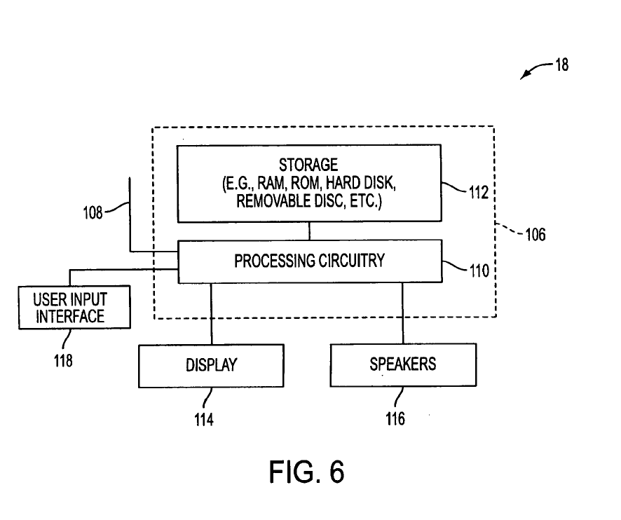

The user television equipment and user computer equipment arrangements described above are merely illustrative. A more generalized embodiment of illustrative user equipment is shown in FIG. 6.

As shown in FIG. 6, control circuitry 106 is connected to input/output 108. Input/output 108 may be connected to one or more communications paths such as paths 26, 27, 28, 42, 46, and 48 of FIG. 1. Television and music programming may be received via input/output 108 (e.g., from programming sources 12, servers or other equipment such as server 36, service providers such as service provider 50, and television distribution facility 14). Program schedule information for an interactive television program guide may be received from data source 30 via input/output 108. Input/output 108 may also be used to receive information from data source 30 for other interactive television applications. The user may use control circuitry 106 to send commands, requests, and other suitable information using input/output 108.

Control circuitry 106 may be based on any suitable processing circuitry 110 such as processing circuitry based on one or more microprocessors, microcontrollers, digital signal processors, programmable logic devices, etc. Memory (e.g., random-access memory and read-only memory), hard drives, DVD drives, CD drives, or any other suitable memory or storage devices may be provided as storage 112 that is part of control circuitry 106. Tuning circuitry such as one or more analog tuners, one or more MPEG-2 decoders or other digital video circuitry, or any other suitable tuning or video circuits or combinations of such circuits may also be included as part of circuitry 106. Encoding circuitry (e.g., for converting over-the-air or cable analog signals to MPEG signals for storage) may also be provided. The tuning and encoding circuitry may be used by the user equipment to receive and display or play or record a particular television or music channel or other desired audio and video content (e.g., video-on-demand content or requested network-based or local video recorder playback). Television programming and other video and on-screen options and information may be displayed on display 114. Display 114 may be a monitor, a television, or any other suitable equipment for displaying visual images. Speakers 116 may be provided as part of a television or may be stand-alone units. Digital music and the audio component of videos displayed on display 114 may be played through speakers 116.

A user may control the control circuitry 106 using user input interface 118. The user input interface 118 may be any suitable user interface, such as a mouse, trackball, keypad, keyboard, touch screen, touch pad, voice recognition interface, remote control, etc.

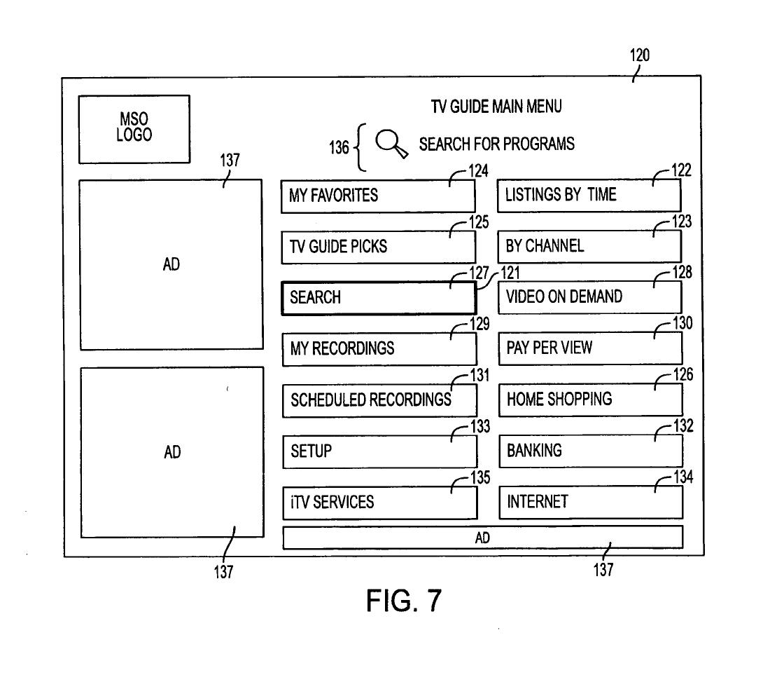

An illustrative menu 120 that may be displayed on the user's display screen is shown in FIG. 7. As shown in FIG. 7, menu 120 may provide the user with an number of selectable options. The options shown in FIG. 7 are merely illustrative. Any suitable options may be provided if desired.

A user of user equipment 18 (e.g., a user of user television equipment 20 or a user of user computer equipment 22, or a user of any other suitable user equipment device) may invoke an interactive television menu such as menu screen 120 by pressing menu button 88 (FIG. 4). Remote control 72 (FIG. 4) or other user interface 118 (FIG. 6) may be used to position highlight region 121 on top of selectable options such as options 122-135. If the user selects option 122 or 123, a screen of program listings may be displayed. Option 124 may be used to display program listings for channels designated by the user as “favorites.” Option 125 may be used to provide program listings selected for promotion by a service provider (e.g., a program guide service provider, a cable operator, etc.). Option 126 may be used to invoke a home shopping service. Options 127 may be used to search program listings by title, time, category, or any other criteria. Option 128 may be selected to display options related to video-on-demand services. Option 129 may be selected to display an interactive list of previously recorded recordings and option 131 may be selected to display an interactive list of programs scheduled for recording. Option 130 may be selected to display pay-per-view program listings and pay-per-view services options. If the user selects option 132, the user may be presented with an opportunity to access home banking functions. Option 133 may be selected to change system setup options and option 134 may be selected to launch a web browser or other application for accessing the Internet. Option 135 may be selected to access other interactive television services. When the user selects an option with highlight region 121 from menu screen 120, the user's selection may be described in information display region 136.

If desired, program guide screens such as menu screen 120 and other interactive television application screens may include selectable advertisements 137. Any suitable advertisements may be provided, including panel advertisements, banner advertisements, advertisements provided between program listings, advertisements provided on certain program listings or other portions of the screen, or any other suitable advertisements. A user may use cursor keys 82 of remote control 72 (FIG. 4) to position a highlight region on an advertisement of interest and may select the highlighted advertisement using OK key 84. Users of other user interfaces may make appropriate selections using the buttons or controls available through those interfaces (e.g., using voice commands if the user interface involves a voice recognition arrangement, etc.).

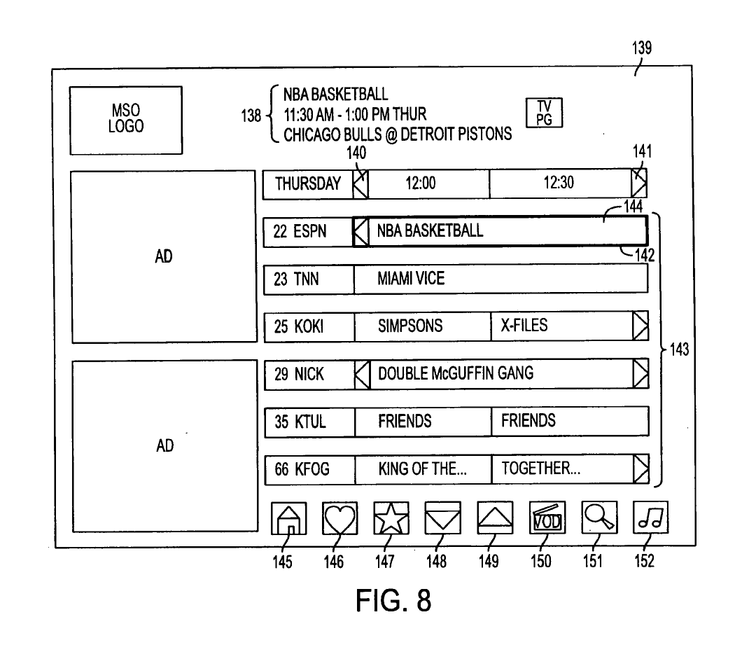

An illustrative program guide screen 138 that may be displayed for the user is shown in FIG. 8. Program guide screen 138 may be displayed, for example, when the user selects program listings option 122 of FIG. 7, when the user selects a suitable option from within an interactive television program guide application or other interactive television application, or when the user presses an appropriate remote control button such as guide button 96 or otherwise uses user input interface 118 to indicate a desire to view program listings.

Program guide screen 138 may contain a grid or list of program listings 143. Program listings 143 may include program titles, channels, scheduled broadcast times, and any other suitable program schedule information. Highlight region 142 may be used to select a desired program listing 144. Program Information for selected programs may appear elsewhere on program guide screen 138 (e.g., in program information display region 139). If the user presses OK key 84 when a program listing for a current program is highlighted, the interactive television application may tune to the channel for that program. If the user presses OK key 84 when a program listing for a future program is highlighted, the interactive television application may provide the user with an opportunity to set a reminder for that program or to record that program.

Other functions that the interactive television application may provide include the ability to set favorites or establish preferences or other settings. For example, the user may select a particular channel for the program guide to automatically tune to when the user equipment is turned on. The user may also select favorite programs, favorite channels, etc. The program guide or other interactive television application may provide the user with the ability to establish parental control settings, the ability to search for programming of interest, and the ability to view program descriptions, advertisements, text, graphics, and video, etc. These are merely illustrative examples of interactive television functions that may be provided by interactive television system 10. Other suitable interactive television functions may be provided if desired.

A user may access program listings (e.g., program listings of the type shown in FIG. 8) by using the interactive television application to select an on-screen option such as option 122 and 123 of FIG. 7, by pressing a dedicated guide button such as guide button 96 on remote control 72, by selecting any other suitable button or on-screen option, etc. In the example of FIG. 8, program listings are currently being displayed for television programs that air between 12:00 noon and 1:00 PM. As shown by arrows 140 and 141, the user may use right or left cursor keys to navigate to other times (e.g., to direct the interactive television application to display appropriate screens of program listings 143 for different time periods). If desired, the user may select options or press keys (or use user input interface 118 to otherwise enter suitable commands) that direct the interactive television application to display program listings organized by channel, by genre, by service type (e.g., pay-per-view or regular broadcast television), etc.

Selectable options, such as options 145, 146, 147, 148, 149, 150, 151, and 152, may be provided as part of program guide screen 138 or any other program guide screen for providing access to various interactive television application features. For example, option 145 may be used to display a home screen or main menu, such as menu screen 120 of FIG. 7. Option 146 may be selected to display program listings for channels designated by the user as “favorites.” Option 147 may be selected to display listings of recommended programs using highlight region 142. Scroll indicators 148 and 149 may be used to navigate down and up through program listings. Option 150 may be selected to display information related to video-on-demand services. Option 151 may be selected to search television program listings by title, time, category, or any other suitable criteria. Option 152 may be selected to display information related to digital music services.

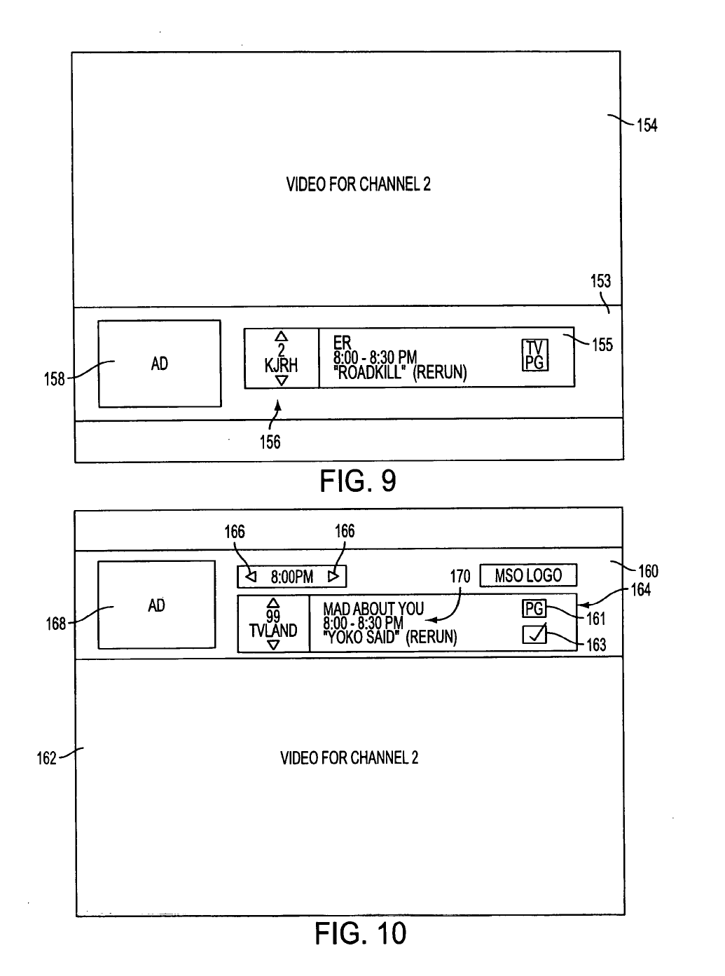

The interactive television application may provide a “flip” tuning feature. As shown in FIG. 9, when the user invokes the flip mode, flip display 153 may be provided over a portion of a channel (i.e., channel 2) that the user is currently tuned to and is watching on display screen 154. Flip display 153 contains information (in region 156) on the program 155 appearing on the current channel (channel 2) to which the set-top box 60 or other user equipment is tuned. The user may change the channel using channel up and down keys on the remote control or using user interface 118 to issue other suitable channel change commands. This simultaneously changes the channel to which the set-top box 60 or other user equipment is tuned and the channel information displayed in region 156 (and the associated program information 155).

The flip display 153 may be removed manually or automatically (e.g., after a few seconds or other suitable time period of user inactivity). When the user starts changing channels again, the flip display 153 may be displayed again.

The flip feature of the interactive television application therefore allows the user to view program information for the channel that the user is currently viewing as the user changes channels. In the example of FIG. 9, the flip display 153 is displayed in the form of an overlay on top of the current channel. If desired, the video for the current channel may be reduced in size and the flip information (e.g., the program title and channel information for the current program) may be displayed at a location on the periphery of the reduced-size video (e.g., at the bottom, side, or top of the reduced-size video).

An advertisement 158 or other content may be provided in the flip display region if desired. Other optional information that may be displayed in flip display 153 includes information on the scheduled broadcast times for the program 155, ratings information, program descriptions, and other program-related information.

The interactive television application may also be used to provide a browse feature. As shown in FIG. 10, when the user invokes the browse feature (e.g., by pressing an up or down cursor key), browse display 160 may be displayed as an overlay over a portion of the channel (i.e., channel 2) that is being displayed on the user's display screen 162 and to which the user is currently tuned. Browse display 160 may initially contain information on the current channel. For example, browse display 160 may, when initially invoked by the user, contain the title of the current program and information on the current channel such as the current channel number, call letters, and network logo.

When the user presses the up or down cursor key (or enters other suitable commands using user interface 118), the browse display may be changed to display information on the programming available on other channels. In the example of FIG. 10, the user has pressed the cursor keys repeatedly, until the user has browsed to channel 99. The video that is being displayed on display screen 162 has not changed in this example (channel 2 is still being displayed).

As indicated by arrows 166, the user may use right and left cursor keys 82 (or other suitable controls) to browse to other time slots (e.g., to view information related to programming that is scheduled for broadcast at a later time). Browse display 160 may contain an advertisement 168, information 170 on scheduled program times, program descriptions and other program-related information and icons such as check icon 163 (to indicate that a reminder has been set for a given program) and ratings icon 161.

If the user locates a currently available program of interest on another channel, the user may press the OK key 84 to direct the interactive television application to tune the user equipment to that channel.

The browse display 160 may be removed manually or may be removed automatically from display screen 162 after a suitable period of user inactivity (e.g., after a few seconds or a minute or two).

If desired, the browse display can be displayed on the periphery of the video for the current program rather than as an overlay. The video for the current channel may be reduced in size accordingly.

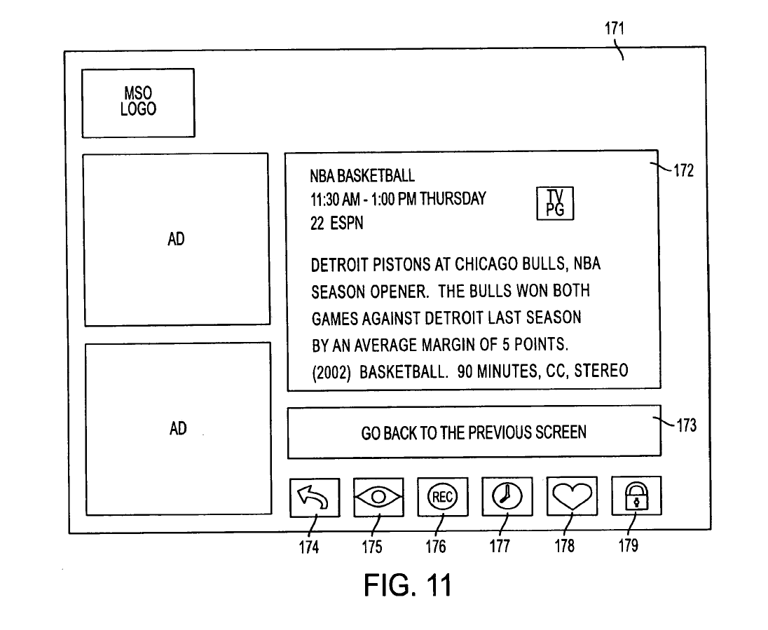

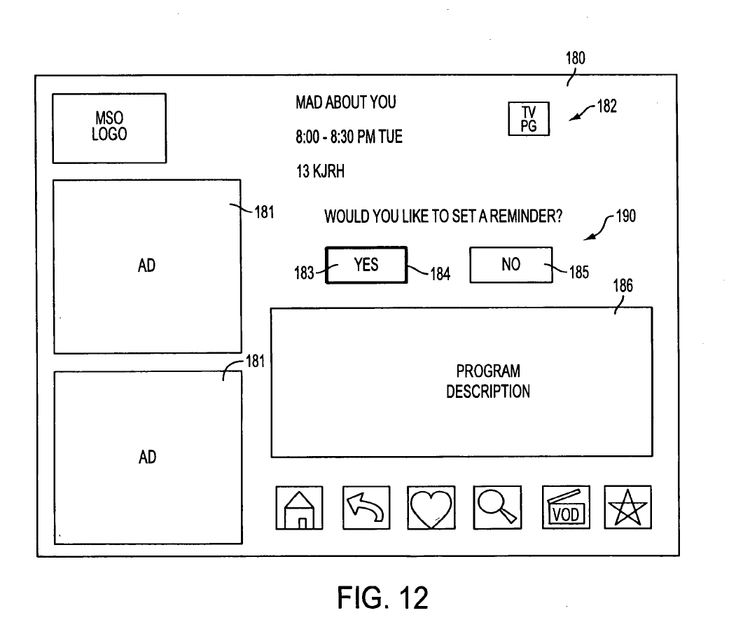

When the user has indicated interest in a program (e.g., by positioning highlight region 142 of FIG. 8 on top of a given program listing, by tuning to a program, by viewing a program listing on the flip banner of FIG. 9 or the browse banner of FIG. 10, etc.), the user may press info key 90 (FIG. 4) to obtain more information for that program. Illustrative info screens 171 and 180 that may be displayed when a user presses info button 90 are shown in FIGS. 11 and 12, respectively. Screens such as screens 171 and 180 may be provided when a user selects a program listing from a interactive television application screen (e.g., program guide screen 138 of FIG. 8). Info screen 171 of FIG. 11 may include a detailed description 172 of a program selected by the user. Description 172 may include, for example, the title, time, channel, and rating of the program, or any other suitable information. As in FIG. 8, selectable options may be provided as part of info screen 171 to provide access to various interactive television application features. For example, option 174 may be used to return to the previous program guide screen. Option 175 may be used to tune to the selected program or set a reminder for the selected program (e.g., the program for which information is displaying in description 172). Option 176 may be selected to display recording options and services for the selected program. Option 177 may be selected to display options for adding a reminder for the selected program. Option 178 may be used to display options for adding the selected program or channel to a user's favorites, and option 179 may be used to display options for providing a parental lock on the selected program. Selectable options for other interactive television application features may also be provided. A highlight region may be used to select any of the selectable options provided by a program guide screen. Information describing a highlighted option may be provided, for example, in information display region 173.

Information screens may include advertisements. For example, info screen 180 of FIG. 12 may include selectable advertisements 181. Information regions on screen 180 such as title region 182 and program description region 186 may be used to display information on the selected program such as title information, ratings information, plot summary information, information about actors, genre, critics ratings, etc.

Region 190 may be used to inform the user of the possibility of setting a reminder for the selected program, of tuning to the channel showing the selected program, of recording the selected program, of purchasing the selected program if it is a pay-per-view program, of parentally controlling the selected program, of configuring a related profile or preference settings, or performing any other suitable action related to the selected program. Region 190 may also be used to provide additional information related to the selected program. The user may position highlight region 184 on top of either yes option 183 or no option 185 or any other suitable options (e.g., options to tune to the channel, to record the program, to purchase the program, to parentally control the program, to configure the preference settings; etc.). When the user presses the OK key 84, the interactive television application may then take appropriate actions. If the user opts to set a reminder for the program listed in the info screen 180, the interactive television application may display a pop-up reminder overlay on top of the video for the channel that the user is currently watching just before the program associated with the reminder is scheduled to begin, or any suitable display screen that is active at the time that the reminder pops up (e.g., a program listings screen).

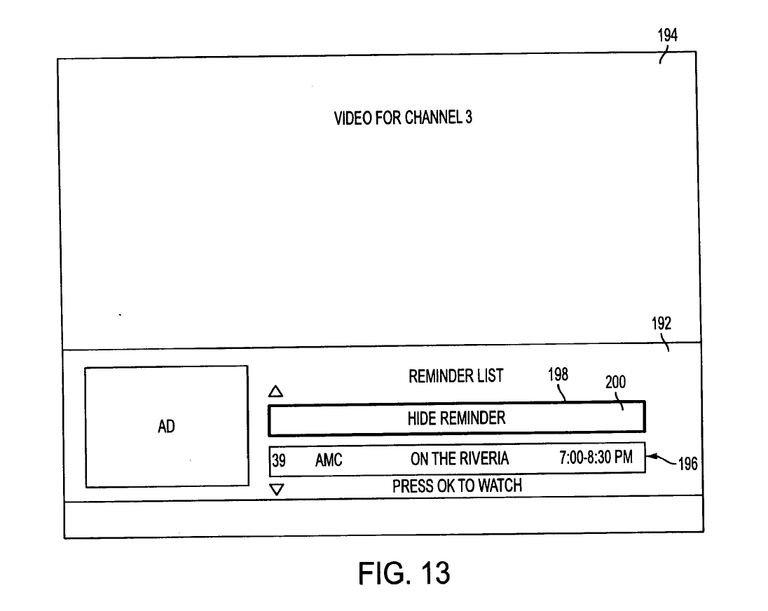

An illustrative reminder is shown in FIG. 13. In the example of FIG. 13, the user is watching channel 3. The current time is 6:58 PM. Previously, the user set a reminder for the program “On The Riviera,” which is scheduled to be shown on channel 39 at 7:00 PM. Because the program for which the user set the reminder is just about to begin, the interactive television application displays reminder list 192 as an overlay on top of the video for channel 3 that is being presented on display screen 194. The reminder list may contain a list of one or more programs for which the user has set reminders. In the example of FIG. 13, one program listing 196 (“On The Riviera”) is displayed.

The user can tune to a program by selecting that program from the reminder list 192. For example, the user may position highlight region 198 on listing 196 and may select that listing by pressing the OK key 84. The interactive television application may then tune the user to the channel for the desired program (i.e., channel 39 in this example).

The user can close the reminder list by pressing the OK key 84 while hide reminder option 200 is highlighted.

The reminder list may be displayed at any suitable time (e.g., at 0-15 minutes before the program of interest is to begin, at a user-selected time before that program, etc.). Moreover, the reminder list may be displayed around the periphery of the video for the current channel and the video for the current channel may be displayed in a reduced-size window. These are merely illustrative examples. Any suitable arrangement may be used to notify the user of upcoming programs or in-progress programs for which the user has set reminders and other programs of interest.

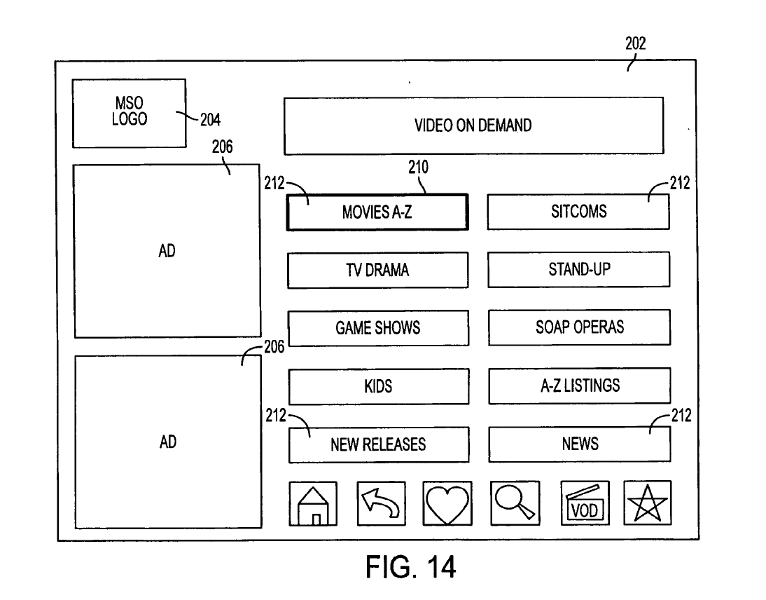

The interactive television application may be used to provide the user with access to video-on-demand content. The user may, for example, be provided with an option such as video-on-demand option 128 on menu screen 120 of FIG. 7. When the user selects option 128, the interactive television application may display a screen such as video-on-demand categories screen 202 of FIG. 14. Screen 202 may include logos such as logo 204, selectable (or non-selectable) advertisements such as advertisements 206, and a screen title 208. The user may position highlight region 210 on an option 212 corresponding to a video-on-demand category of interest.

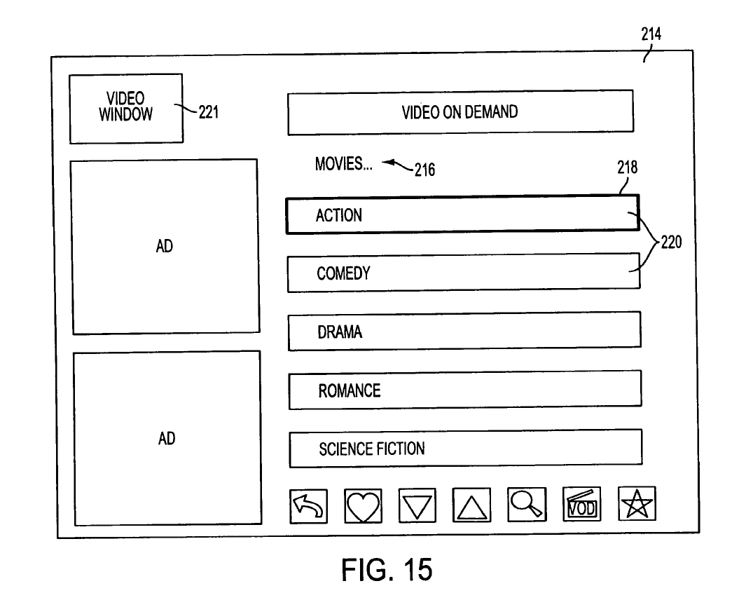

When the user selects the video-on-demand category of interest from screen 202, the interactive television application may display a display screen such as subcategory selection screen 214 of FIG. 15. In the example of FIG. 15, the subcategories screen 214 contains subcategory options 220 corresponding to movies, because (in this example) the user selected movies A-Z option 212 from screen 202 in FIG. 14. Video window 221 may be provided in any video-on-demand information screen and may provide information relating to a video-on-demand program selected by the user or any other suitable video information.

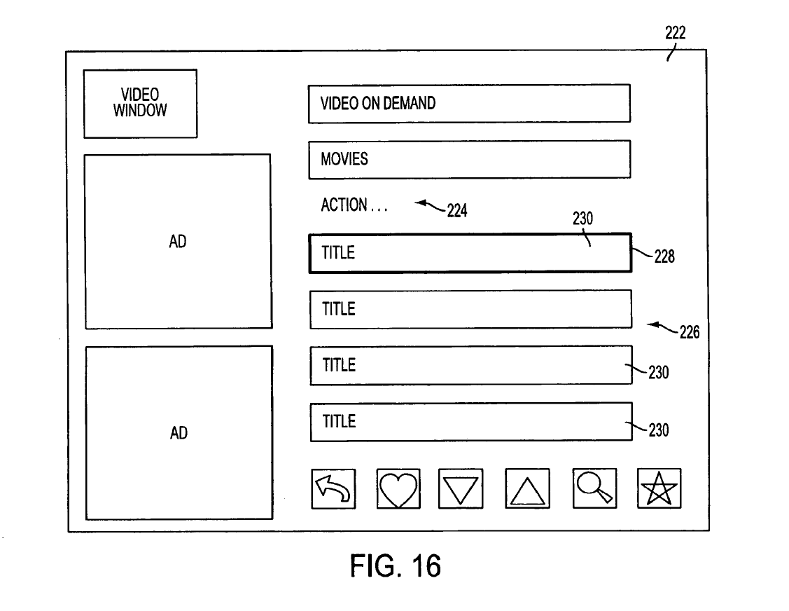

The user may position highlight region 218 onto a desired subcategory 220 and may press OK key 84 to view a list of available video-on-demand content associated with that subcategory. An illustrative display screen 222 that the interactive television application may display for the user when the action subcategory option 220 (FIG. 15) is selected is shown in FIG. 16. As shown in FIG. 16, display screen 222 may include information identifying the selected subcategory 224. Screen 222 may also include a list 226 of titles 230 (or other content indicators). The user may position highlight region 228 on a desired video-on-demand title 230 and may press the OK key to proceed with the selection of that title.

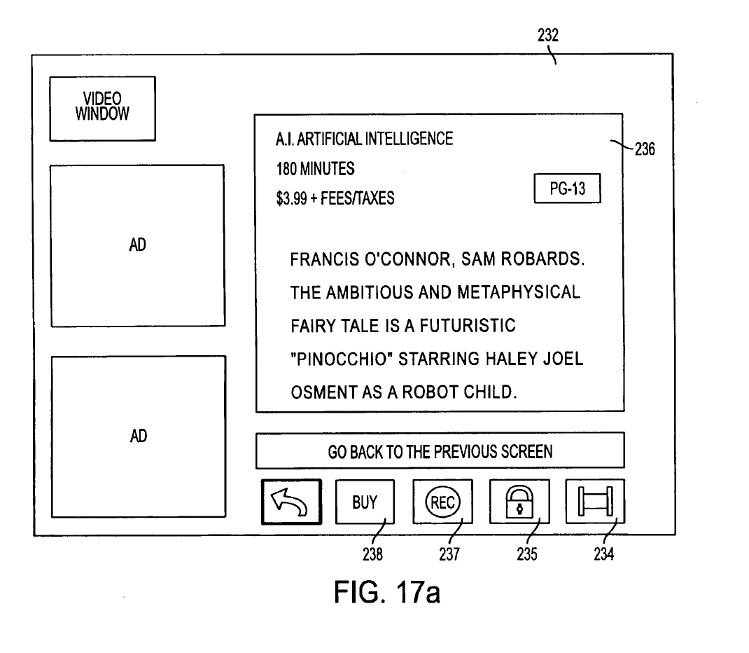

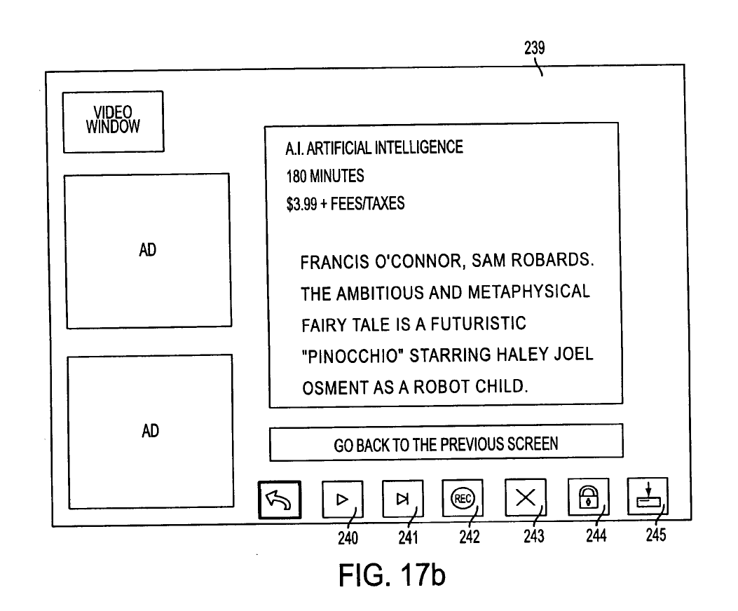

Selecting a desired video-on-demand title 230 from title selection screen 222 may direct the interactive television application to display a video-on-demand information screen such as information screen 232 of FIG. 17a. Screen 232 may include information 236 on the selected video-on-demand content, such as title, run time, price, rating, and a description of the selected video-on-demand content.

Selectable options, such as options 234, 235, 237, and 238 may be provided as part of screen 232 to provide access to various interactive television application features. For example, option 238 may be selected to access options for ordering the selected video-on-demand content. Option 237 may be used to access options for recording the selected content, and option 235 may be used to access options for setting parental control locks for the selected content. If the user selects option 234, the interactive television application may display a video clip containing information on the video-on-demand content of interest (e.g., a promotional video such as a preview, a trailer, a review, etc.). The video clip may be delivered to the user equipment 18 from a server such as server 36 or server 56 of FIG. 1 or from equipment at a service provider such a service provider 50. The interactive television application may also provide the user with additional information on the video-on-demand content in response to the user selecting option 234. Other suitable selectable options may also be provided on screen 232 (e.g., a program package information and purchase option, options for searching program listings for related content, etc.).

If a user requests information for video-on-demand content that has already been ordered, the interactive television application may provide video-on-demand information screen such as screen 239 of FIG. 17b, which may include selectable options different than those provided for screen 232 of FIG. 17a. For example, option 240 may be used to start playing selected video-on-demand content from the program position most recently viewed. Option 241 may be used to present the selected content from the beginning, and option 242 may be used to access options for recording the content. Option 243 may be used to remove the selected content from a listing of the ordered and available content. Option 244 may be used to access options for setting parental control locks for the selected content. If the selected content is being accessed over a network or being provided by a network storage device, option 245 may be used to store the content on a local storage device.

In response to a user ordering selected content (e.g., by selecting an on-screen order option such as option 238 of FIG. 17a, or by using remote control 72 or any other suitable input device 118 to order content, etc.), the interactive television application may deliver the ordered video-on-demand content to the user equipment from a server such as server 36 or server 56 or from a service provider such as service provider 50. The communications paths and communications network 34 of FIG. 1 may be used in delivering the requested content.

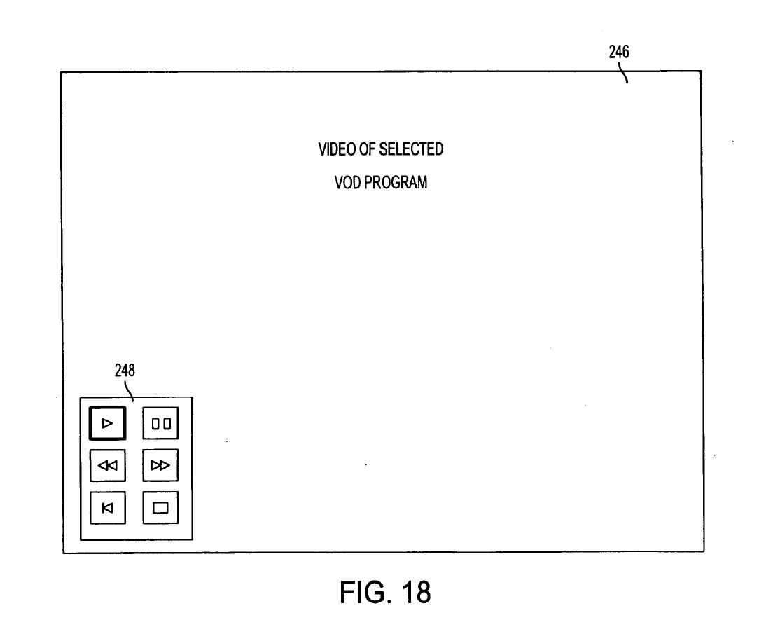

The ordered video-on-demand content may be displayed for the user on a display screen such as video-on-demand playback screen 246 of FIG. 18. As shown in the lower portion of screen 246, interactive options may be displayed in a toolbar 248 or other suitable format. The interactive options 248 (or similar remote control buttons) may allow the user to rewind the video-on-demand content to the beginning, rewind, play, fast-forward, pause, stop delivery of the video-on-demand content, or perform other video playback options. The arrangement of FIG. 18 is merely illustrative. For example, the video-on-demand content may be played back in a reduced size window (of fixed or user-selectable size).

The interactive television system 10 may be used to support video recorder functions. The video recorder functions may be supported using local arrangements (e.g., arrangements in which a personal video recorder or other suitable equipment in the user's home is used to record videos on a local hard drive or other storage device) and network-based arrangements (e.g., arrangements in which network equipment such as servers 36 and 56 or equipment at a service provider such as service provider 50 is used to store video and data for the user). Combinations of these arrangements may also be supported using system 10.

In a local video recorder arrangement (sometimes called a personal video recorder arrangement or local digital video recorder arrangement), video recordings are stored locally on the user equipment. Information on which videos have been recorded may also be maintained locally. Program guide information (e.g., titles, rates, descriptions, categories, etc.) may also be maintained for the recorded videos. When a user desires to view a list of the recordings that the user has stored on the user equipment, the interactive television application may retrieve this information from local storage and may display this information to the user locally on user equipment 18. The user may then select a desired recording to play back.

In a network-based video recorder arrangement (sometimes called a client-server video recorder arrangement), videos may be stored on the network (e.g., at servers such as servers 36 and 56 or at a service provider such as service provider 50). Information on which programs have been recorded for the user may be stored locally and on the network (e.g., at servers such as servers 36 and 56 or at a service provider such as service provider 50).

Network-based recordings may be made in a number of ways. For example, some or all of the regularly-broadcast television programming provided by programming sources 12 may be automatically recorded or copies of this programming otherwise maintained on a suitable network storage device such as server 36, server 56, or equipment at a service provider such as service provider 50. If the user chooses to “record” a program, no actual recording need be made, because a copy of the desired program already exists on the system. With this type of arrangement, virtual recordings take the place of real recordings.

The user may be given a “personal area” on the network. The personal area may be accessed when the user enters an appropriate personal identification number or by virtue of the user's connection to the network through a known or trusted communications path (e.g., when the user is connected through a dedicated cable path to a server at a cable system headend such as a server 56 at television distribution facility 14 of FIG. 1).

The personal area may be used to maintain a list of the video content that the user has recorded. Whenever the user directs the network-based video recorder portion of the interactive television system to make a recording, the system updates the user's personal area to make it appear as though an additional “real” copy of the requested recording has been made. The network-based video recorder implemented with this approach therefore conserves storage space, while providing users with the illusion of access to a network-based video recorder dedicated to their personal use.

Alternatively, there may be no personal area and each user may have access to all previously recorded content to which they had rights when originally broadcast.

As another example, some or all of the content for which a user requests that a recording be made may be recorded by creating actual copies (e.g., digital recordings) of the requested content. These actual copies may be stored on network equipment (e.g., servers such as servers 36 and 56 or equipment at a service provider such as service provider 50).

Programs recorded onto a network server may be copied to a user's local storage.

A combination of these approaches may be used if desired. For example, some content may be automatically retained by the system (e.g., copies of popular programming). The user may make virtual recordings of this material. The presence of the virtual recordings may be reflected in the user's personal area. Other content may be stored in the form of actual recordings at the direction of the user (e.g., less popular content). The presence of these recordings may also be reflected in the user's personal area.

Regardless of the way in which network-based recordings (virtual or real) and local recordings are made, the interactive television application may be used to provide the user with interactive display screens that assist the user in making recordings, managing recordings (e.g., editing recordings, deleting recordings, renaming recordings, sending recordings to other users over the communications paths of FIG. 1, etc.), playing back recordings, viewing information about recorded programs, etc.

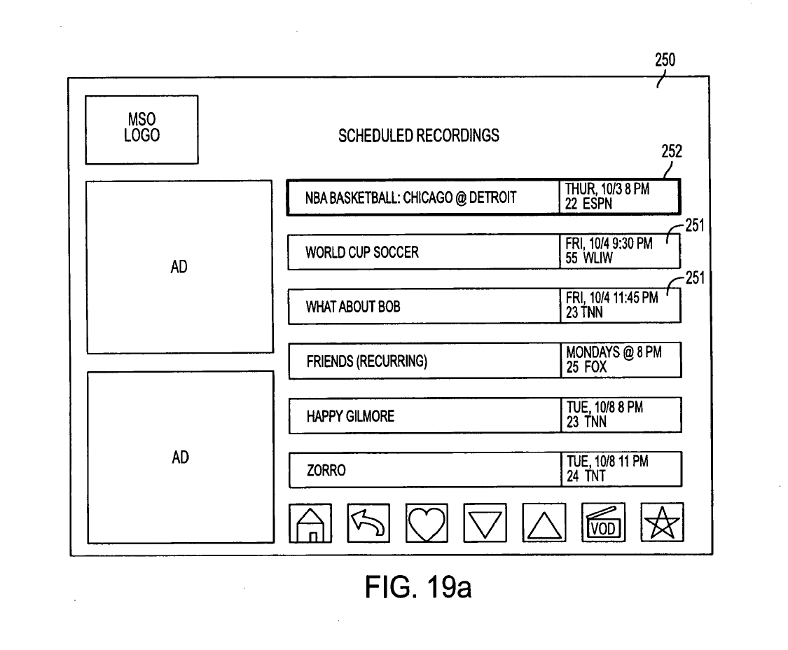

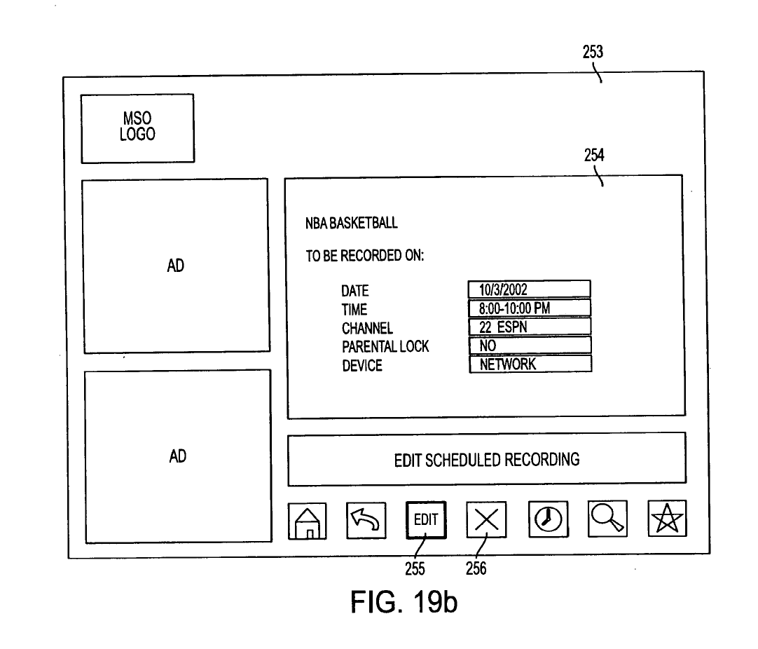

Once a program has been selected by a user for recording, the selected program may be presented in an interactive list of programs scheduled to be recorded. An illustrative scheduled recordings screen 250 that may be displayed for the user on user equipment 18 is shown in FIG. 19a. Screen 250 may be displayed by the interactive television application when the user selects an option provided by another program guide screen, such as program guide screen 120 of FIG. 7 or any other suitable option. Screen 250 may include, for example, a list of programs scheduled to be recorded 251. A highlight region 252 may be used to select a scheduled recording from the list. The user may position highlight region 252 on a desired scheduled recording and select the scheduled recording using an appropriate key of remote control 72.

Information about a scheduled recording selected by the user may be presented in a screen such as screen 253 of FIG. 19b. Screen 253 may include scheduled recording information 254, which may show the date, time, and channel for which a program is to be recorded. Information 254 may also indicate which device has been designated to record the program and whether a parental lock is set for the program scheduled to be recorded. The user may edit information 254 by selecting edit option 255 using a highlight region. Other selectable options may be provided in screen 253, for example cancel option 256 which the user may select to cancel the scheduled recording.

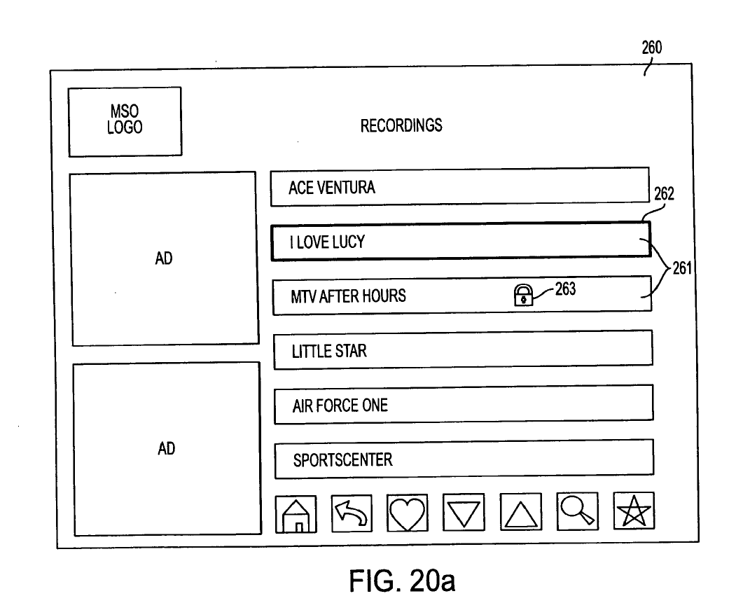

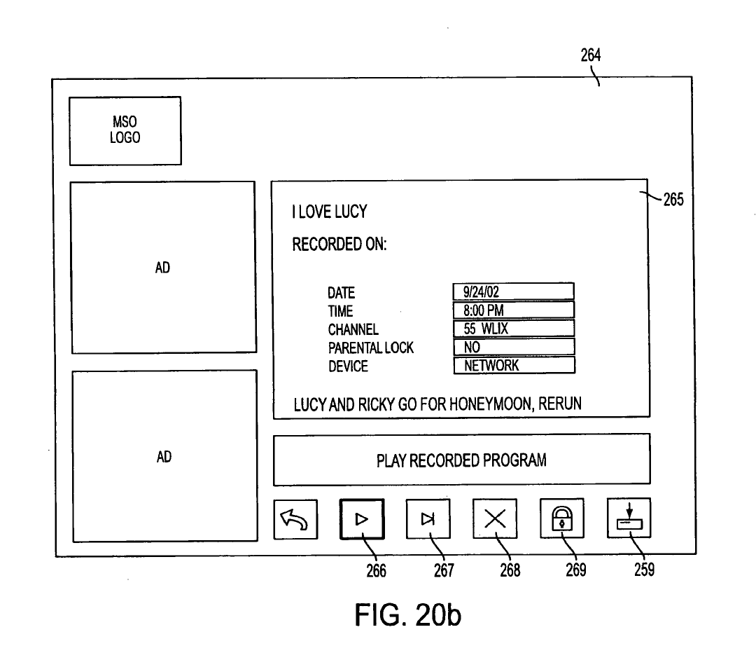

Once a program has been recorded, a program guide screen may be presented to display recorded programs. An illustrative video recordings screen 260 that may be displayed for the user on user equipment 18 is shown in FIG. 20. Screen 260 may be displayed by the interactive television application when the user selects an option provided by another program guide screen, such as program guide screen 120 of FIG. 7 or any other suitable option. The recordings 261 may be local recordings that are stored on the user's equipment 18 or may be real or virtual network-based recordings (e.g., network-based content stored on equipment such as server 36 or server 56 or at service provider 50). In a network-based video recorder environment with a personal area, screens such as screen 260 provide access to all or part of the user's personal area. The user may navigate through the personal area using remote control 72 or other suitable user interface 18.

Screen 260 may include a list of the user's recordings 261. Recording listings may include the time and channel the program was recorded or any other suitable information. The user may position highlight region 262 to select a recording of interest (e.g., to view that recording, to view information about that program, to delete the program, etc.). The user may position highlight region 262 on a desired recording and select the recording using an appropriate key of remote control 72.

Information about a recording selected by the user may be presented in a screen such as screen 264 as illustrated in FIG. 20b. Screen 264 may include recording information 265, which may show the date, time, and channel the program was recorded. Information 265 may also show whether a parental lock is set for the recording and what device has been designated to store the recording. The user may play the recording by selecting option 266. The user may play the selected recording from the beginning by selecting option 267. Option 268 may be selected to delete the recording from the list of recordings. Option 269 may be used to set a parental lock for the selected recording. If the selected recording is being stored on a network video storage device, the user may select option 259 to transfer the recording to a local storage device. On-screen options may be selected using a highlight region and a remote control, or by any other suitable method.

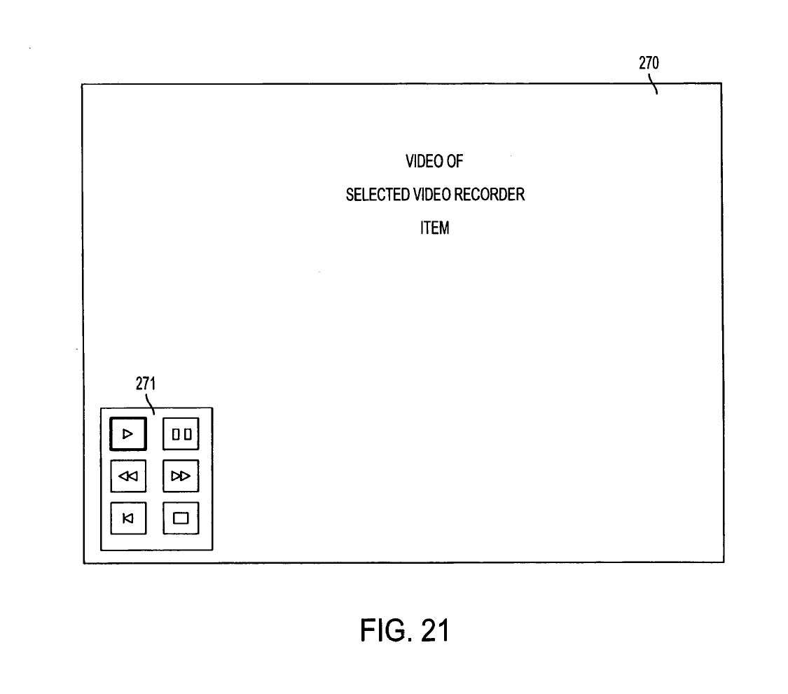

When a given recording is selected for play back, for example by selecting play option 266, a display screen such as display screen 269 of FIG. 21 may be presented. Display screen 269 may include the video 270 of the selected program that is being played back to the user and options 271 for controlling the video. Options 271 may, for example, include options that allow the user to rewind the video to the beginning, to rewind or reverse the video, to play the video, to fast-forward the video, to pause the video, or to stop the video. Control of these functions and other interactive television application functions may be supported using on-screen options, dedicated or multi-purpose keys on remote control 72 or other user devices, or other suitable arrangements involving user interface 118. When on-screen options are used, the options may be displayed in the form of one or more overlays on top of video 270 or video 270 may be provided in a reduced-size window and the options displayed outside of this window.

With the arrangement of FIGS. 20 and 21, the user can browse the user's recordings and can play back (and control the playback) of these recordings. Recordings that are stored locally on user equipment 18 may be played back by retrieving these recordings from the local hard drive or other storage on which the recordings are maintained. Recordings that are stored on the network may be played back from the network equipment on which the recording content is stored. User equipment 18 may receive such content in the form of a real-time video stream or a file download and the interactive television application may play back the received content using a display screen arrangement of the type shown in FIG. 21.

The user may record programming by indicating interest in a program for recording by highlighting a program of interest on a suitable display screen provided by the interactive television application and pressing a record key, by selecting a program for recording from a flip or browse display, by tuning to a desired program and selecting an appropriate record button, by selecting a record option from an information screen, etc. For example, the user may highlight a program in a program listings screen such as screen 138 of FIG. 8, or may display a program listing of interest on a flip display such as flip display 153 of FIG. 9 or on a browse display such as browse display 160 of FIG. 10. When the user presses a suitable remote control key such as record key 86 of FIG. 4, the interactive television application may record the desired program.

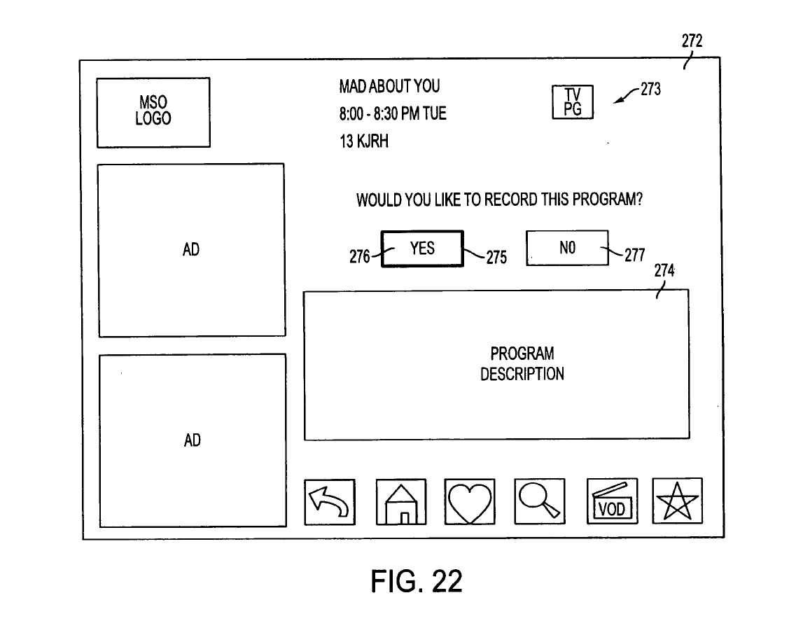

The interactive television application may automatically record the program that the user selected or may provide one or more additional confirmation and information screens after the user presses the record key 86. As an example, the interactive television application may display a screen such as record set-up screen 272 of FIG. 22. As shown in FIG. 22, screen 272 may include title and ratings information in region 273 and a program description 274. The user may be provided with information on the scheduled broadcast time for the selected program. If the user desires to record the program, the user may position highlight region 275 on top of YES option 276 and may press OK key 84. If the user does not wish to record the program, the user may position highlight 275 on top of NO option 277 and may press the OK key 84. If desired, other options such as series recording options, recording quality options, and buffer time options may be provided.

When the user directs the interactive television application to record a given program, the interactive television application will record the program using the local capabilities of user equipment 18 or using the network-based video recorder capabilities of the system 10, depending on the equipment of the user, the capabilities of system 10, and system and user settings.

After the program has been recorded, the user may use the interactive television application to view information on the user's recordings (e.g., using a display screen arrangement of the type shown in FIG. 20). These techniques for supporting recording functionality in the interactive television application are merely illustrative. Any suitable arrangement for recording (as real recordings or as virtual recordings and locally or on network equipment) may be used if desired.

The interactive television application may allow the user to establish parental control settings. For example, the user may lock a particular program, program rating, a channel, a type of content (e.g., violent or sexual content), or may establish a parental control setting that blocks all television viewing during a particular period of time. A user may be required to enter a personal identification number (PIN) to unlock blocked content.

With one illustrative arrangement, a parent (or other suitable user) may select a program to block by highlighting the program listing for that program in a suitable program listings screen (e.g., a screen such as screen 138 of FIG. 8). After highlighting the program to be blocked, the parent may press lock key 92 on remote control 72 (FIG. 4). The parent may also access options for setting parental locks by selecting an on-screen parental control lock option provided by the interactive television application (e.g., option 234 of FIG. 17a, option 244 of FIG. 17b, etc.).

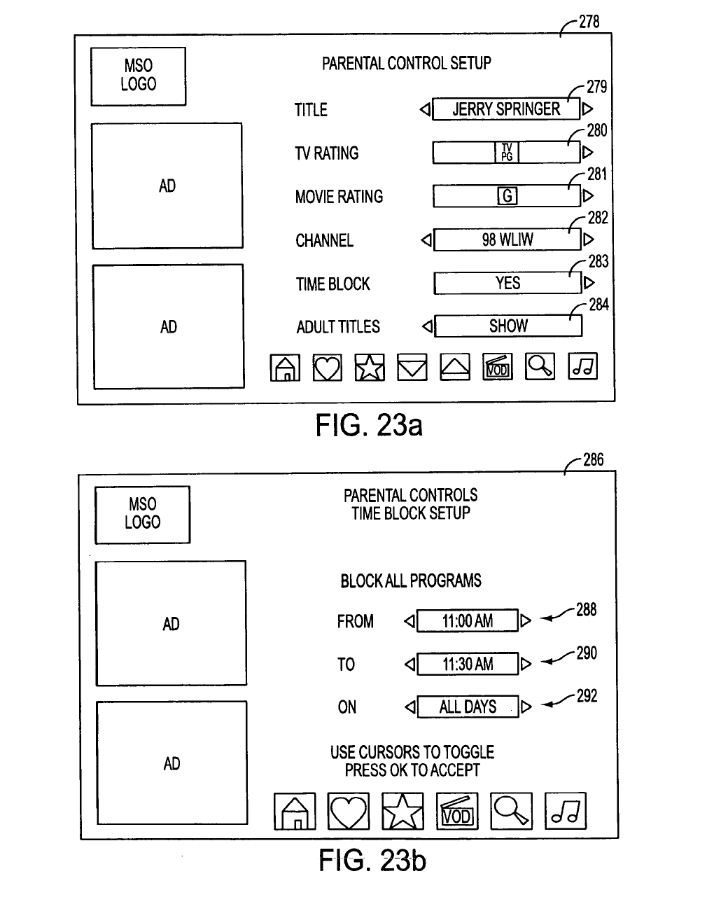

In response to a user selecting an on-screen option or remote control key to access parental control lock options, the interactive television application may display a display screen such as parental controls display screen 278 of FIG. 23a. Parental controls options may be accessed from a main menu, a selected program, or any other suitable program guide screen. Users may set parental locks for a selected program or a range of programming by selecting from various criteria. For example, users may select to block programs according to title 279, TV rating 280, movie rating 281, channel 282, or any other suitable criteria. Block ratings options 280 and 281 may allow users to block all programming with a given rating (e.g., the same rating as the selected program or a user-input rating or range of ratings). The user may be provided with other options for applying parental lock settings by selecting, for example, (YES/NO) time lock option 283. A user may also select to hide or show adult titles by selecting option 284. Other selectable options may also be provided in screen 278.

If the user has selected “YES” for time block option 183, a time block sub-menu may be provided, for example, screen 286 of FIG. 23b. The user may use the on-screen options of screen 286 to set a beginning time (option 288) and ending time (option 290) for the parental control time period. The user may use option 292 to make the parental control setting effective for all days of the week, certain groups of days (e.g., week days or weekend days), or a particular day or days. The user may press OK key 84 when finished. Other selectable options may also be provided as part of screen 286.

The parental control screens 278 and 286 of FIGS. 23a and 23b are merely illustrative. Any suitable on-screen options or other user interface arrangement may be used to allow a parent (or other user) to block (parentally-control) programming airing during a particular period of time, programming on a particular channel or channels, programming with a certain rating, individual instances of certain programs, etc.

Media-on-demand (e.g., video-on-demand or audio-on-demand) is a service that allows users to request media content for immediate delivery to the home over a cable or other suitable communications path. Media-on-demand may be provided to the user in real time (e.g., substantially instantaneously or within a few seconds). After a user requests a media-on-demand program, a stream of video or audio may be delivered to the user equipment for viewing or listening. This stream may be buffered and/or stored to improve performance (e.g., presentation without interruption or pausing).

On-demand media, such as video-on-demand programming, may be branded or sponsored by one or more different vendors, such as television networks or cable channels (e.g., Starz, HBO, Showtime, etc.). The content itself is generally stored on servers, such as server 56 or server 36. A server may provide content for one vendor or for multiple vendors. VOD content is delivered to the users by the users' television distribution facility 14 (MSO). The vendor may select which content is offered and may have rights in the content. Each vendor may provide a different and/or exclusive selection of video-on-demand content than other vendors. For example, HBO may provide on-demand content that is or will be available exclusively on regular HBO channels. In accordance with these difference, the program guide or other interactive television application may display vendor-specific interface screens for each vendor. These screens allow users to access and request video-on-demand content from the vendors.

For example, a user may wish to request video-on-demand content that is available from a vendor, such as Starz. In response to the user, for example, tuning to a designated Starz VOD channel or any other suitable VOD channel or selecting a Starz option on an on-screen menu or pressing a Starz button on a remote control, the interactive television program guide application may display a Starz-specific interface screen that allows the user to access and request content from the vendor Starz. In some embodiments, the content in this vendor-specific interface screen may be limited to the content provided by that particular vendor. The vendor-specific interface screen may also include distinguishable and identifiable vendor-specific interface elements characteristic of the vendor. For example, the vendor-specific interface screen may include the Starz logo, colors used by Starz, or any other suitable vendor-specific interface element.

In some embodiments of the present invention, the interactive television program guide application may provide the user with a vendor-specific window that allows the user to access and request on-demand media. The vendor-specific window may appear as an overlay over the display screen that is currently being displayed for the user. For example, when the user directs the application to display a Starz-specific content window while viewing programming, the Starz-specific window may appear as, for example, a pop-up screen overlay, a window overlay, a banner, or any other suitable interface. These exemplary vendor-specific overlays may include both vendor-specific and invariant interface elements.

Vendor-specific screens may be displayed by the interactive television application to allow a vendor to better promote and target their video-on-demand content to the user from within the exclusive context of their vendor-specific interface screens. Vendor-specific screens may also promote branding of the specific vendor. Users may also use the vendor-specific screen increase the likelihood of finding a program of interest by directing the application to display a vendor-specific interface screen for a preferred vendor.

In some embodiments, vendor-specific screens may be used to facilitate access control to video-on-demand content by the interactive television program guide application. For example, the interactive television program guide application may need to retrieve the user's subscription privileges or parental control options (e.g., parental blocking) to determine whether to enable or restrict access to Starz content. In some embodiments, access control may be implemented for each vendor independently. Parent control options or other access controls may be more easily imposed (without unduly confusing the user) by controlling user access to the Starz-specific interface screens. Alternatively, the user may set restrictions and parental control options that applies to all vendors.

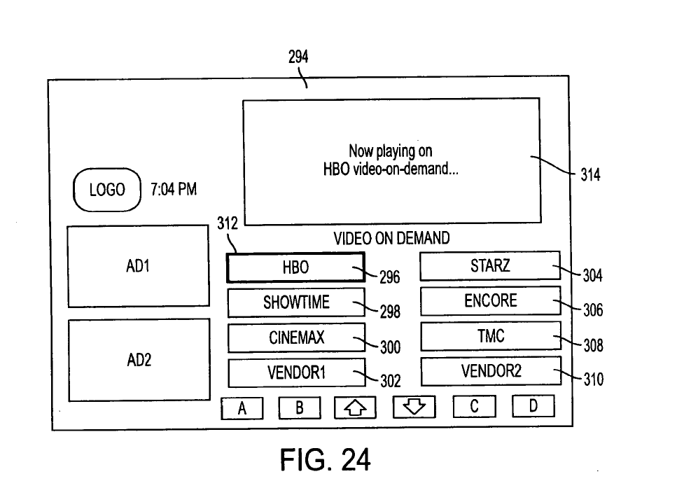

Vendor-specific screens may be displayed by the interactive television application in response to a user's selection or action. For example, in response to the user selecting the “VIDEO-ON-DEMAND” option 128 of FIG. 7 or pressing a VOD key on the remote control, the interactive television application may display a video-on-demand vendor selection screen. FIG. 24 shows an illustrative video-on-demand vendor screen in accordance with various embodiments of the present invention. Screen 294 comprises options 296-310 corresponding to video-on-demand vendors. The interactive television application may allow the user to select a video-on-demand vendor from screen 294 by, for example, positioning highlight 312 on one of vendor options 296-310 and pressing the “OK” button on the remote control. In response to the user selecting one of options 296-310, the interactive television application may display a vendor-specific interface screen corresponding to the selected vendor. For example, if the user selects Starz option 304, the interactive television application may display a Starz-specific interface screen in a window 314. Other content, such as advertisements, video clips, trailers, or previews, may also be displayed in window 314. These advertisements or previews may be provided by the interactive television application or by the vendors.

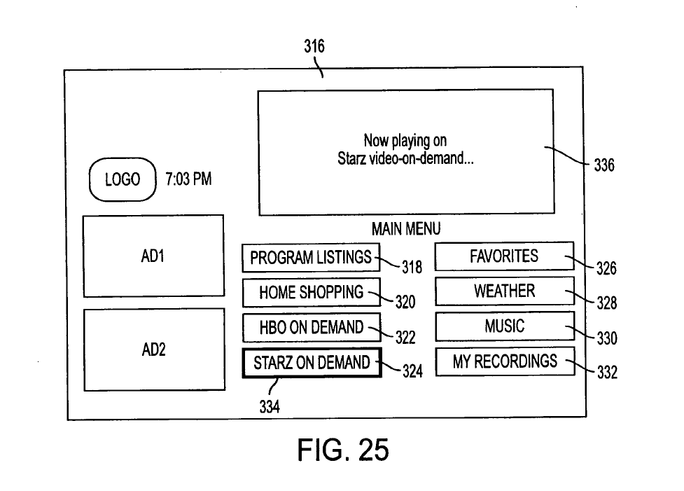

The application may also allow the user to access vendor-specific interface screens by displaying a main menu screen, such as illustrative main menu screen 316 as shown in FIG. 25. Available on-screen options 318-332 may include options 322 and 324 that correspond to video-on-demand content vendors. The user may select “Starz On Demand” by positioning highlight 334 on option 324 and pressing the “OK” button on the remote control. In response, the interactive television application may display a Starz-specific interface menu. Other content, such as advertisements, video clips, trailers, or previews, may also be displayed may also be displayed in window 336.

In some embodiments, the interactive television application may display a vendor-specific interface screen in response to the user pressing a designated button or key on an input device, such as remote control 72 of FIG. 4, or by selecting a designated navigational icon on an interface screen, such as navigational icon 150 on FIG. 8.

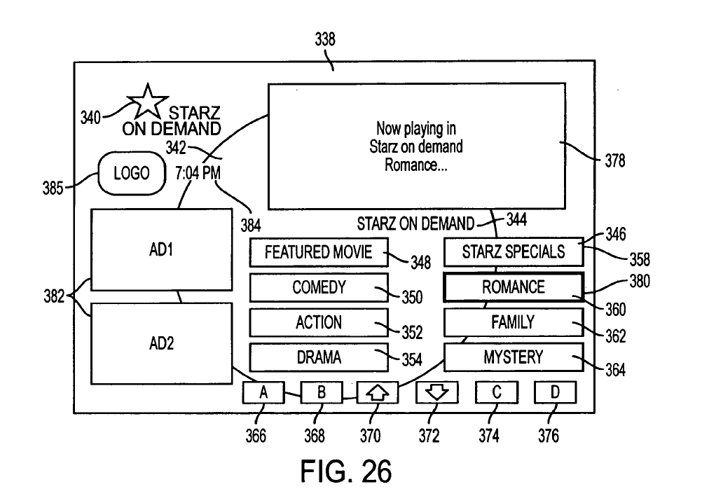

In response to the user requesting to receive vendor-specific on-demand media, the interactive television application may display a vendor-specific interface screen, such as illustrative vendor-specific screen 338 as shown in FIG. 26. Screen 338 may include vendor-specific interface elements. Vendor-specific interface elements may include vendor logo 340, vendor screen background 342, vendor menu title 344, and vendor option labels 346. Vendor-specific interface elements may be provided by the vendor or any other suitable entity.

In addition, vendor-specific interface elements may also include definitions that define the appearance of elements such as options 348-364 or navigational icons 366-376. These definitions may specify characteristics such as labels, fonts, typefaces, colors, patterns, borders, and the like for these elements. The appearance definitions may also specify an action or behavior that results from the selection of an option or icon element by the user. Examples of actions or behaviors may include directing the interactive television application to display another screen (either generic or vendor-specific) or directing the interactive television application to sort the displayed options in accordance with a specified criterion. In another suitable approach, the interactive television application may provide the user with an animation every time a vendor-specific screen is displayed (e.g., a shooting star for Starz on demand screens). Other vendor-specific interface elements may be included as appropriate depending on the layout and context of the screen.

The interface elements may also be selectable. In response to the user selecting one of the interface elements, the interactive television application may perform an action. For example, in response to the user selecting one of options 348-364, the interactive television application may display another Starz-specific interface. In response to the user selecting one of navigational icons 370 or 372, the interactive television application may display additional menu options (e.g., additional categories of on-demand media, additional features, etc.). In another example, in response to the user selecting one of navigational icons 366, 368, 374 or 376, the interactive television application may direct the application to display other interface screens pre-configured to correspond to the selected navigational icon.

The application may also display vendor-provided content, such as advertisements or previews, in window 378. These advertisements or previews may be for video-on-demand content, television programs, products, services, or the like. The previews and advertisements may include videos, pictures, text, sounds, animation, and the like or any suitable combination thereof. The advertisements and previews may be directed to video-on-demand content provided by the vendor.

Window 378 may also be selectable by the user. For example, in response to the user selecting window 378, the interactive television application may provide the user with additional information about the subject of the advertisement, preview, or any other content displayed in window 378. In response to the user selecting window 378, the interactive television application may prompt the user to order'or request the subject of the advertisement, such as a video-on-demand movie.

In some embodiments, advertisements, previews, or other suitable content displayed in window 378 may be displayed in response to a user's actions or requests. For example, in response to the user positioning highlight 380 on one of options 348-364, the interactive television application may display an advertisement in window 378 that is related to the highlighted option. Alternatively, the interactive television application may also display advertisements in window 378 that are not provided by the vendor.

Interface screen 338 also includes interface elements that may be invariant regardless of the vendor, such as MSO logo 385, advertisements 382, clock 384, and highlight 386. In some embodiments, one or more of options 348-364 or navigational icons 366-376 may also be invariant. These elements may be included in each vendor-specific interface screen irrespective of the vendor. Invariant elements may be neither vendor-specific nor provided by the vendor. These interface elements may also be selectable by the user in order to direct the interactive television application to perform an action, such as displaying additional information or confirming the user's request to order a product.

In some embodiments, because highlighting and selection of user-selectable interface elements are managed by the interactive television application, the position and size of selectable elements remains substantially fixed. This may create a consistent interface for the user, and may facilitate the interactive television application in determining what is being highlighted or selected on the screen by the user. For example, the positions and sizes of options 348-364 and navigational icons 366-376 may be unchanged between interface screens. However, as described above, the appearance of interface elements may be defined by the vendor.

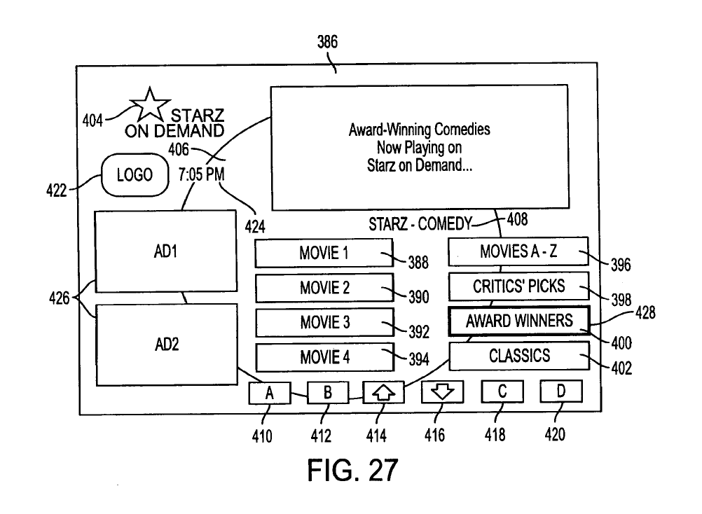

Screen 338 may be one of multiple Starz-specific screens that may be displayed by the interactive television application. Some vendor-specific screens may be displayed by the interactive television application in response to the user's actions, such as the user selecting an option on a vendor-specific screen. For example, the user may position highlight 380 and select “COMEDY” option 350 on screen 338. In response to the user selecting “COMEDY” option 350, the interactive television application may display a “Starz-Comedy” screen 386 as shown in FIG. 27. Screen 386 may include video-on-demand titles 388-394, as well as additional category options 396-402. Some of the labels (e.g., programs and categories) of foregoing options 388-402 may be provided by the vendor. For example, the vendor may provide actual titles for labeling options 388-394.

Screen 386 may include many of the same vendor-specific interface elements as in screen 338, including vendor logo 404, screen background 406, and menu title 408. The appearance of options 388-402 and navigational icons 410-420 may also be defined by the vendor as described above. In addition, screen 386 also comprises invariant interface elements such as interactive application logo 422, clock 424, advertisements 426, and highlight 428. As described above with respect to screen 338, attributes such as the sizes and positions of options 388-402 and navigational icons 410-420 may be invariant. All of the foregoing elements may be user selectable, such that the user's selection directs the interactive television application to provide a suitable response. In addition to screen 386, the interactive television application may display other vendor-specific interface screens as necessary for the user to access and request the vendor's video-on-demand content.

In the vendor-specific interface screens described above, at least part of each screen preferably has a consistent layout irrespective of the vendor branding for that screen. This consistency includes, for example, the positions and sizes of both the vendor-specific and invariant interface elements, particularly those that are user selectable. A consistent interface may be more user friendly than an inconsistent interface.

In view of this consistency between interface screens, the interactive television application may more easily generate a vendor-specific interface screen by starting with an interface template that includes the invariant, non-vendor-specific interface elements. The interactive television application may then incorporate the vendor-specific elements into the template to generate a vendor-specific screen, without requiring modifications to the underlying software code. The use of interface templates therefore reduces the burden on the application provider (e.g., the provider of the interactive television program guide) when generating a multitude of vendor-specific interfaces. This also ensures the consistency of the interface regardless of the vendor.

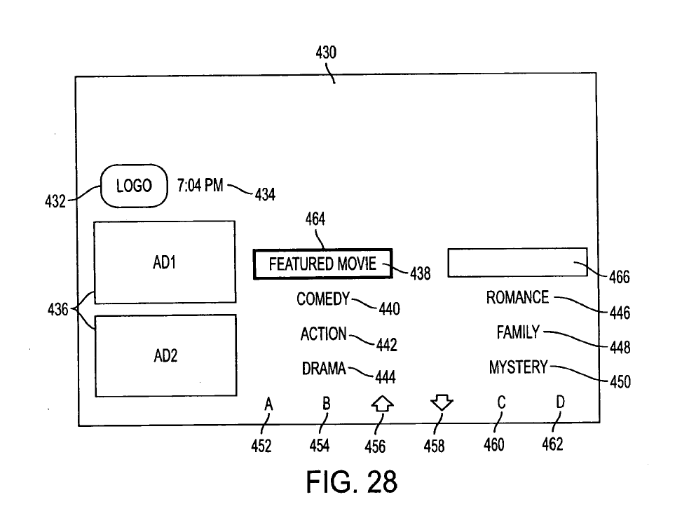

FIG. 28 shows an illustrative interface template screen prior to insertion or incorporation of the vendor-specific interface elements in accordance with various embodiments of the present invention. Interface template screen 430 includes elements such as logo 432, clock 434, and advertisements 436. Interface template screen 430 also includes menu options 438-450, navigational icons 452-462, and a highlight region 464. The properties of these options and icons, such as the position and size, may be invariant. In some embodiments, the appearance and labels for the options and icons may be specified by the vendor. For example, the vendor may provide a label or title for option 466. The vendor may also define an action that is performed in response to the user selecting an option or icon.

Interface templates may also include attributes for the vendor-specific interface elements to be incorporated into the interface template. These attributes may include, for example, information about the preferred size and position of vendor-specific interface elements. Guided by these attributes, the interactive television application may incorporate the vendor-specific elements into the appropriate positions in the template. For example, the interface template may include preferred dimensions of logo 340 as shown in FIG. 26 in order to ensure proper incorporation in the template by the interactive television application. If the logo provided by the vendor does not conform to these dimensions, the interactive television application may modify it by, for example, scaling or cropping.

In some embodiments, default screen interface elements may be used by the interactive television application to substitute for absent or inappropriate vendor-specific elements. For example, if the vendor does not provide a color for the user-selectable options, the interactive television application or the template may define a default color to be used. Similarly, if a vendor does not provide a screen background, or provides one that cannot be incorporated into the template, a default generic background may be selected by the interactive television application.

The interactive television application or the template may define default user-selectable icons and options. These default icons and options may appear on the interface screen if corresponding vendor-specific icons and options are not provided by the vendor. For example, if the vendor does not provide a sufficient number of program titles to occupy the available selectable title options 388-394, the interactive television application may provide default titles to be incorporated in the template for the absent vendor-specific elements. Alternatively, the default interface element provided by the interactive television application may be a blank, unselectable icon so as maintain the appearance of the vendor-specific display screen. The interactive television application or template may also define mandatory user-selectable icons or options that appear on the interface screen irrespective of the vendor. For example, the interactive television application may define a default program title to appear in every vendor-specific display screen. Similarly, certain navigational icons, such as icons 366-376, may be provided by the application by default.

In a similar manner, the interactive television application or the template may define default actions to be performed that are to be associated with icons or options if vendor-specific actions are not defined or provided by the vendor. Mandatory actions or behaviors, may also be provided by the application or the template. A mandatory action or behavior may be associated with an icon or an option and cannot be supplanted by a vendor-specific action or behavior. For example, one of navigational icons 366-376 may, if selected by the user, direct the interactive television application to display a home page of the application. Because such an icon may appear on every display screen for convenience to the user, this resulting action may be defined by the interactive television application or the template by default, irrespective of the vendor.

The interactive television application that generates and displays the vendor-specific interface screens may be implemented locally on the user equipment. The application may also be implemented in a distributed fashion, such as in a client-server architecture. Other distributed architectures may be used if desired.

The system may include a remote server configured to support the interactive television application on the user equipment. The remote server may provide new or updated versions of the interactive television application. When the application retrieves the interface template or the vendor-specific interface elements, the remote server may also provide the interface templates and vendor-specific interface elements. Examples of remote servers that may support the interactive application and the user equipment, such as server 36, server 56, or equipment at service provider 50 or data source 30, are illustrated on FIG. 1.

The interface templates are preferably stored on the user equipment when used by the application. The templates may be embedded in the application, or stored in memory or other storage on the user equipment. These templates may have been previously stored on the user equipment, or a remote server may be configured to provide these interface templates to the application. The remote server may provide the templates to the interactive television application with or without requiring a request from the interactive television application. The remote server may be further configured to replace or update templates stored on the user equipment.

Vendor-specific interface elements may also be provided by a remote server. The remote server may receive these elements from the vendors by a variety of methods, including by network, fax, email, internet file transfer, regular mail, and the like. Each vendor may provide their elements to the remote server regularly, or when warranted by changes to the elements and/or templates. Alternatively, the vendor may provide their interface elements following a request from the remote server. Vendor-specific interface elements may be collected centrally (e.g., at data source 30) and then distributed to a remote server at a distribution facility (e.g., server 56 at television distribution facility 14) via communication paths (e.g., communication path 32). The distribution facility may then provide the vendor-specific elements to individual user equipment (e.g., equipment 18, 20 and 22 via paths 26, 27 and 28, respectively).

After a remote server has received and stored the vendor-specific interface elements in a suitable format, the remote server may provide these elements to the application. The application may retrieve the vendor-specific elements after the user has directed the interactive television application to display a vendor-specific interface screen of the corresponding vendor, or the application may request regularly available elements from the remote server. Alternatively, or in addition to the foregoing, the remote server may provide vendor-specific elements to the application without requiring a request from the application.

Once vendor-specific elements have been provided to the interactive television application, the elements may be stored locally on the user equipment in memory or other storage. Once stored in this manner, the application may retrieve the locally stored elements instead of retrieving the same elements from the remote server. The interactive television application may preferentially store the most frequently or most recently used elements. The locally stored elements may be deleted regularly, periodically, or otherwise to ensure that current vendor-specific interface elements are re-retrieved periodically, regularly, or otherwise from the remote server. The remote server may also regularly, periodically, or otherwise provide updated and new vendor-specific elements to the user equipment.

After vendor-specific interface screens have been generated, the application may store frequently or recently used screens in memory or other storage in the user equipment. Once stored in this manner, the application may display a stored interface screen instead of generating it anew. The locally stored screens may be deleted regularly, periodically, or otherwise to ensure that the interface screens displayed by the application are re-generated in order to incorporate current vendor-specific interface elements and templates.

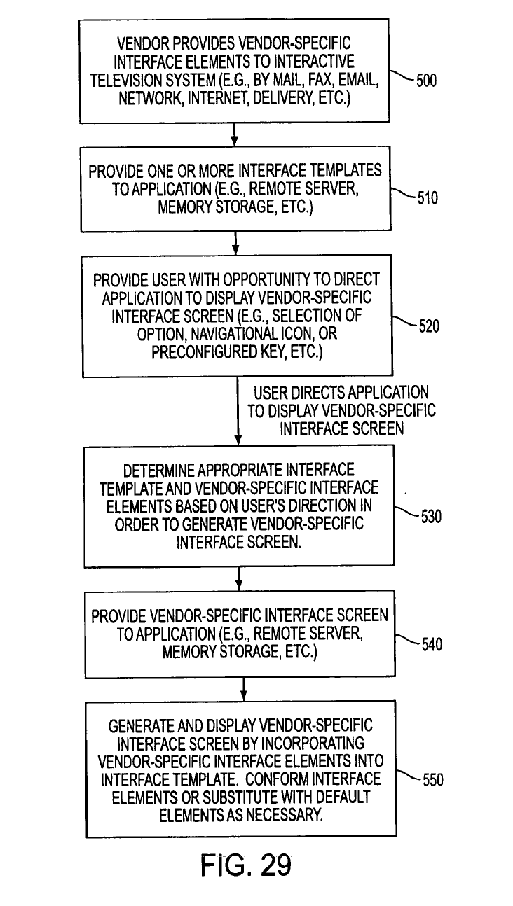

FIG. 29 is an illustrative method for generating a vendor-specific interface in accordance with various embodiments of the present invention. At step 500, a vendor provides vendor-specific interface elements to a remote server. A vendor may provide these elements by email, network, fax, physical delivery, internet file transfer, or the like or any suitable combination thereof. The remote server may be, for example, a service provider, data source, television distribution facility, or the like. With multiple vendors, each vendor may provide their respective elements to the remote server independent of each other. Vendor-specific elements may also be collected centrally at, for example, a data source, and then sent to the remote server for distribution.

At step 510, the interactive television application retrieves one or more interface templates. The templates may be embedded in the interactive television application, stored on the user equipment, provided by the remote server, or any suitable combination thereof. If the templates are to be provided by the remote server, the remote server may provide them with or without a request from the application. More than one interface template may be provided to application in this manner.

At step 520, the interactive application provides the user with an opportunity to select a video-on-demand content vendor. For example, the interactive television application may display an interface screen having vendor options that are selectable by the user. The interactive television application may also display an interface screen with one or more user-selectable navigational icons that are pre-configured to correspond to content vendors. Alternatively, a user input device having pre-configured or programmable keys or buttons corresponding to content vendors may be provided to the user.

In step 530, after the user has performed an appropriate action or selection, the interactive television application determines the appropriate interface template and vendor-specific interface elements based on the user's selection. The required vendor-specific interface elements are determined by the vendor selected by the user. The appropriate interface template is determined by the type of interface screen requested by the user.

In step 540, the application may retrieve the appropriate vendor-specific interface elements from the remote server. Alternatively, the server may have previously provided the vendor-specific elements to the interactive television application. In either case, the elements retrieved by the interactive television application may be stored locally on the user equipment in memory or other storage. Accordingly, the interactive television application may use previously stored interface elements instead of requesting them from the server.

In step 550, the interactive television application may generate and display a vendor-specific interface screen by using the provided interface template and vendor-specific interface elements. The interactive television application may modify the vendor-specific interface elements, such as by cropping or scaling, to ensure their proper incorporation in the template. The interactive television application may also incorporate default or generic interface elements if the vendor-specific interface elements cannot be used with the template or are not provided by the vendor. Generation of the vendor-specific interface screen by the interactive television application may also include defining the appearance and behavior of other elements on the screen, such as options and icons, in accordance with the vendor's specifications.

The interactive television application displays the vendor-specific interface screen on the user equipment. This interface screen may allow the user to perform an action that directs the interactive television application to display other vendor-specific interface screens. These other vendor-specific interface screens may be generated and displayed in substantially the same manner as described in the foregoing flow chart.

Once a vendor-specific interface screen has been generated by the interactive television application in step 550, the interactive television application may store the screen in memory or other storage on the user equipment. If the user later directs the interactive television application to display the same interface screen, the interactive television application may display the stored screen instead of generating it anew.

The sequence of the steps described above and in FIG. 29 is merely illustrative. It is understood that the order of the foregoing steps may be modified in such a manner that the overall result is substantially the same. For example, interface templates may be provided to the interactive television application at a step later than what is illustrated in FIG. 29, and may not need to be provided in advance of the vendor-specific interface elements. Similarly, providing the user with the opportunity to direct the application to display a vendor-specific interface screen may follow or precede either or both the retrieval of the template and the vendor-specific elements by the application. Other variations in the foregoing sequence of steps can be contemplated by one skilled in the art.

Thus, systems and methods for providing customizable video-on-demand menus using templates are provided. One skilled in the art will appreciate that the present invention can be practiced by other than the described embodiments, which are presented for purposes of illustration and not of limitation, and the present invention is limited only by the claims which follow.

1. A method for providing a media-on-demand display screen using an interactive television application implemented on user equipment, the method comprising:
retrieving, using a processor, an interface template;
retrieving, using the processor, at least one vendor-specific interface element associated with a media-on-demand vendor;
determining, using the processor, if visual attributes of the at least one vendor-specific interface element are inappropriate for incorporation into the interface template;
incorporating, using the processor, the at least one vendor-specific interface element into the interface template when the at least one vendor-specific interface element is appropriate for incorporation; and
in response to receiving a user request for media-on-demand content associated with the media-on-demand vendor, displaying a media-on-demand display screen that is associated with the vendor, wherein the display includes the interface template and the incorporated interface element.

2. The method of claim 1, wherein the interface template includes an invariant element.

3. The method of claim 1, wherein the interface template includes at least one default element.

4. The method of claim 3, wherein the incorporating comprises:
incorporating the default element into the interface template when visual attributes of a vendor-specific interface element are inappropriate for incorporation, wherein the default element corresponds to the vendor-specific interface element with the inappropriate visual attributes.

5. The method of claim 3, wherein the incorporating comprises:
determining if a vendor-specific interface element is absent; and
incorporating the default element that corresponds to the absent vendor-specific interface element into the interface template.

6. The method of claim 1, wherein the retrieving the interface template comprises providing the interface template to the interactive television application by a remote server.

7. The method of claim 1, wherein the retrieving the vendor-specific interface elements comprises providing the vendor-specific interface elements to the interactive television application by a remote server.

8. The method of claim 1, wherein the retrieving the vendor-specific interface elements comprises accessing the vendor-specific interface elements stored locally on the user equipment.

9. The method of claim 1, wherein the interactive television application comprises an interactive program guide, the method further comprising using the interactive program guide to display the media-on-demand display screen on the user equipment.

10. The method of claim 1 further comprising using the interactive television application to display multiple media-on-demand display screens on the user equipment, wherein each of the media-on-demand display screens is associated with a different media-on-demand vendor.

11. The method of claim 1, wherein the media-on-demand display screen includes video-on-demand listings, the method further comprising displaying the video-on-demand listings as part of the vendor-specific media-on-demand display screen.

12. The method of claim 1, wherein the vendor-specific interface elements include vendor-specified definitions, the method further comprising displaying the at least one vendor-specific interface element as part of the vendor-specific interface screen such that the at least one interface element complies with the definitions.

13. The method of claim 12, wherein the vendor-specified definitions include color definitions.

14. The method of claim 12, wherein the vendor-specified definitions include pattern definitions.

15. User equipment for providing a media-on-demand display screen using an interactive television application implemented on the user equipment, the user equipment comprising:
a display;
control circuitry configured to:
retrieve an interface template;
retrieve at least one vendor-specific interface element associated with a media-on-demand vendor;
determine if visual attributes of the at least one vendor-specific interface element are inappropriate for incorporation into the interface template;
incorporate the at least one vendor-specific interface element into the interface template when the at least one vendor-specific interface element is appropriate for incorporation; and
in response to receiving a user request for media-on-demand content associated with the media-on-demand vendor, display a media-on-demand display screen that is associated with the vendor, wherein the display screen includes the interface template and the incorporated interface element.

16. The user equipment of claim 15, wherein the interface template includes an invariant element.

17. The user equipment of claim 15, wherein the interface template includes at least one default element.

18. The user equipment of claim 17, wherein the control circuitry, when configured to incorporate the at least one vendor-specific interface element into the interface template, is configured to:
incorporate the default element into the interface template when visual attributes of a vendor-specific interface element are inappropriate for incorporation, wherein the default element corresponds to the vendor-specific interface element with the inappropriate visual attributes.

19. The user equipment of claim 17, wherein the control circuitry, when configured to incorporate the at least one vendor-specific interface element into the interface template, is configured to:
determine if a vendor-specific interface element is absent; and
incorporate the default element that corresponds to the absent vendor-specific interface element into the interface template.

20. The user equipment of claim 15, wherein the control circuitry, when configured to retrieve the interface template, is configured to receive the interface template from a remote server.

21. The user equipment of claim 15, wherein the control circuitry, when configured to retrieve the vendor-specific interface elements, is configured to receive the vendor-specific interface elements from a remote server.

22. The user equipment of claim 15, wherein the control circuitry, when configured to retrieve the vendor-specific interface elements, is configured to access the vendor-specific interface elements stored locally on the user equipment.

23. The user equipment of claim 15, wherein the interactive television application comprises an interactive program guide, the control circuitry is further configured to use the interactive program guide to display the media-on-demand display screen on the user equipment.

24. The user equipment of claim 15, wherein the control circuitry is further configured to use the interactive television application to display multiple media-on-demand display screens on the user equipment, wherein each of the media-on-demand display screens is associated with a different media-on-demand vendor.

25. The user equipment of claim 15, wherein the media-on-demand display screen includes video-on-demand listings and the control circuitry is further configured to display the video-on-demand listings as part of the vendor-specific media-on-demand display screen.

26. The user equipment of claim 15, wherein the vendor-specific interface elements include vendor-specified definitions and the control circuitry is further configured to display the at least one vendor-specific interface element as part of the vendor-specific interface screen such that the at least one interface element complies with the definitions.

27. The user equipment of claim 26, wherein the vendor-specified definitions include color definitions.

28. The user equipment of claim 26, wherein the vendor-specified definitions include pattern definitions.

29. A system for providing a media-on-demand display screen using an interactive television application implemented on user equipment, the system comprising:
means for retrieving an interface template;
means for retrieving at least one vendor-specific interface element associated with a media-on-demand vendor;
means for determining if visual attributes of the at least one vendor-specific interface element are inappropriate for incorporation into the interface template;
means for incorporating the at least one vendor-specific interface element into the interface template when the at least one vendor-specific interface element is appropriate for incorporation; and
means for displaying, in response to receiving a user request for media-on-demand content associated with the media-on-demand vendor, a media-on-demand display screen that is associated with the vendor, wherein the display includes the interface template and the incorporated interface element.

30. The system of claim 29, wherein the interface template includes an invariant element.

31. The system of claim 29, wherein the interface template includes at least one default element.

32. The system of claim 31, wherein the means for incorporating comprises:
means for incorporating the default element into the interface template when visual attributes of a vendor-specific interface element are inappropriate for incorporation, wherein the default element corresponds to the vendor-specific interface element with the inappropriate visual attributes.

33. The system of claim 31, wherein the means for incorporating comprises:
means for determining if a vendor-specific interface element is absent; and
means for incorporating the default element that corresponds to the absent vendor-specific interface element into the interface template.

34. The system of claim 29, wherein the means for retrieving the interface template comprises means for providing the interface template to the interactive television application by a remote server.

35. The system of claim 29, wherein the means for retrieving the vendor-specific interface elements comprises means for providing the vendor-specific interface elements to the interactive television application by a remote server.

36. The system of claim 29, wherein the means for retrieving the vendor-specific interface elements comprises means for accessing the vendor-specific interface elements stored locally on the user equipment.

37. The system of claim 29, wherein the interactive television application comprises an interactive program guide, the system further comprising means for using the interactive program guide to display the media-on-demand display screen on the user equipment.

38. The system of claim 29 further comprising means for using the interactive television application to display multiple media-on-demand display screens on the user equipment, wherein each of the media-on-demand display screens is associated with a different media-on-demand vendor.

39. The system of claim 29, wherein the media-on-demand display screen includes video-on-demand listings, the system further comprising means for displaying the video-on-demand listings as part of the vendor-specific media-on-demand display screen.

40. The system of claim 29, wherein the vendor-specific interface elements include vendor-specified definitions, the system further comprising means for displaying the at least one vendor-specific interface element as part of the vendor-specific interface screen such that the at least one interface element complies with the definitions.

41. The system of claim 40, wherein the vendor-specified definitions include color definitions.

42. The system of claim 40, wherein the vendor-specified definitions include pattern definitions.

43. Computer-readable media for use in an interactive television application implemented on user equipment, in which the interactive television application provides a media-on-demand display screen, wherein the media is encoded with computer-readable instructions for performing the method comprising:
retrieving an interface template;
retrieving at least one vendor-specific interface element associated with a media-on-demand vendor;
determining if visual attributes of the at least one vendor-specific interface element are inappropriate for incorporation into the interface template;
incorporating the at least one vendor-specific interface element into the interface template when the at least one vendor-specific interface element is appropriate for incorporation; and
in response to receiving a user request for media-on-demand content associated with the media-on-demand vendor, displaying a media-on-demand display screen that is associated with the vendor, wherein the display includes the interface template and the incorporated interface element.

44. The computer-readable media of claim 43, wherein the interface template includes an invariant element.

45. The computer-readable media of claim 43, wherein the interface template includes at least one default element.

46. The computer-readable media of claim 45, wherein the incorporating comprises:
incorporating the default element into the interface template when visual attributes of a vendor-specific interface element are inappropriate for incorporation, wherein the default element corresponds to the vendor-specific interface element with the inappropriate visual attributes.

47. The computer-readable media of claim 45, wherein the incorporating comprises:
determining if a vendor-specific interface element is absent; and
incorporating the default element that corresponds to the absent vendor-specific interface element into the interface template.

48. The computer-readable media of claim 43, wherein the retrieving the interface template comprises providing the interface template to the interactive television application by a remote server.

49. The computer-readable media of claim 43, wherein the retrieving the vendor-specific interface elements comprises providing the vendor-specific interface elements to the interactive television application by a remote server.

50. The computer-readable media of claim 43, wherein the retrieving the vendor-specific interface elements comprises accessing the vendor-specific interface elements stored locally on the user equipment.

51. The computer-readable media of claim 43, wherein the interactive television application comprises an interactive program guide, the method further comprising using the interactive program guide to display the media-on-demand display screen on the user equipment.

52. The computer-readable media of claim 43 further comprising using the interactive television application to display multiple media-on-demand display screens on the user equipment, wherein each of the media-on-demand display screens is associated with a different media-on-demand vendor.

53. The computer-readable media of claim 43, wherein the media-on-demand display screen includes video-on-demand listings, the method further comprising displaying the video-on-demand listings as part of the vendor-specific media-on-demand display screen.

54. The computer-readable media of claim 43, wherein the vendor-specific interface elements include vendor-specified definitions, the method further comprising displaying the at least one vendor-specific interface element as part of the vendor-specific interface screen such that the at least one interface element complies with the definitions.

55. The method of claim 54, wherein the vendor-specified definitions include color definitions.

56. The method of claim 54, wherein the vendor-specified definitions include pattern definitions.

57. The method of claim 1, wherein receiving a user request for media-on-demand content associated with the media-on-demand vendor comprises receiving a user request to display a listing of the media-on-demand content associated with the media-on-demand vendor.

58. The user equipment of claim 15, wherein receiving a user request for media-on-demand content associated with the media-on-demand vendor comprises receiving a user request to display a listing of the media-on-demand content associated with the media-on-demand vendor.

59. The system of claim 29, wherein the means for displaying, in response to receiving a user request for media-on-demand content associated with the media-on-demand vendor, comprises means for displaying, in response to receiving a user request to display a listing of the media-on-demand content associated with the media-on-demand vendor.

60. The method of claim 43, wherein receiving a user request for media-on-demand content associated with the media-on-demand vendor comprises receiving a user request to display a listing of the media-on-demand content associated with the media-on-demand vendor.
